(19) United States
(12) Patent Application Publication
(10) Pub. No.: US 2026/0366703 A1
(43) Pub. Date: Nov. 19, 2026

(54) VEHICULAR LAMP

(71) Applicant: KOITO MANUFACTURING CO., LTD., Tokyo (JP)

(72) Inventors: Takahiro TOTSUKA, Shizuoka-shi, Shizuoka (JP); Aya OKUMURA, Shizuoka-shi, Shizuoka (JP); Ryuichi SUZUKI, Shizuoka-shi, Shizuoka (JP); Mamoru TAKIZAWA, Shizuoka-shi, Shizuoka (JP); Ryo KOMODA, Shizuoka-shi, Shizuoka (JP)

(73) Assignee: KOITO MANUFACTURING CO., LTD., Tokyo (JP)

(21) Appl. No.: 19/143,763

(22) PCT Filed: Dec. 27, 2023
(86) PCT No.: PCT/JP2023/046945

§ 371 Date: Jun. 26, 2025

(30) Foreign Application Priority Data
Dec. 28, 2022 (JP) 2022-212374
Jan. 19, 2023 (JP) 2023-006317
Feb. 9, 2023 (JP) 2023-018119
Feb. 10, 2023 (JP) 2023-019511
Feb. 10, 2023 (JP) 2023-019516

(51) Int. Cl. F21V 15/01; F21S 41/25; F21S 41/29; F21S 45/50; F21V 17/06

(52) U.S. Cl. CPC F21V 15/01; F21S 41/25; F21S 41/29; F21S 45/50; F21V 17/06

(57) ABSTRACT

A vehicle lamp includes a lamp body having an opening in a front surface of the lamp body, and a front lens that is attached to the opening in the front surface of the lamp body and that forms a lamp chamber inside the lamp body. The lamp body includes, inside the lamp chamber, a component support portion, and a semi-cylindrical portion having a semi-cylindrical shape in cross section and surrounding both sides of the component support portion.

### TECHNICAL FIELD

The present invention provides a technique related to a vehicle lamp including a lamp body that is thin and lightweight but that has sufficient strength around a portion where a component support portion is formed.

### BACKGROUND ART

In recent years, there has been a demand for weight reduction of a vehicle lamp from the viewpoint of carbon neutrality, and thus there has been a demand for weight reduction of portions of a lamp body on which components are mounted. On the other hand, in recent years, the number of components mounted on the lamp body, such as sensors provided from the viewpoint of improving the safety, has increased in the vehicle lamp, and there is a demand for increased rigidity, particularly around a component support portion provided on the lamp body.

FIG. 4 and FIG. 5 in Patent Literature 1 disclose a lamp body in which a rib is added to a bracket (a vehicle body attachment portion) that attaches the lamp body to the vehicle body, rather than to an attachment portion for a component in the lamp body, thereby improving the rigidity against an increase in the weight of the lamp body.

In the related art, a structure (an in-lamp structure) provided in a lamp chamber, such as a control unit, is provided in the empty space of the lamp body. For example, in Patent Literature 2, a control unit for swivel driving is fixed in the empty space of the lamp body formed in a box shape. In recent years, from the viewpoint of carbon neutrality, there has been a movement toward weight reduction of the lamp body. However, if the wall thickness of the lamp body is simply reduced, the rigidity of the body may be reduced, and therefore, maintenance of the rigidity of the lamp body is a problem.

There is a lamp body in the related art provided with an engaging portion with which an engaged member is engaged. For example, in Patent Literature 3, a front cover is fixed to the lamp body by an engaging portion having a lance structure provided on the lamp body so as to be prevented from coming off.

### CITATION LIST

### Patent Literature

Patent Literature 1: JP2010-123292A

Patent Literature 2: JP2016-110853A

Patent Literature 3: JP2017-007214A

### SUMMARY OF INVENTION

### Technical Problem

For example, the lamp body shown in FIG. 4 in Patent Literature 1 is formed with attachment holes for a first light source and a second light source. From the viewpoint of improving the rigidity of the lower portion of the attachment hole after the light source is attached, it is conceivable to provide a reinforcing rib as that provided in the brackets on the lower side of the holes for attaching the light source in the lamp body.

While adding the rib to the lamp body increases the rigidity around the light source attachment hole, adding the rib also increases the weight of the lamp body, both of which go against the demand for weight reduction. Therefore, the inventors of the present application considered whether it is possible to improve the rigidity around the component support portion of the lamp body without providing the reinforcing rib.

An object of the present disclosure is to provide a vehicle lamp including a lamp body that is thin and lightweight but that has sufficient strength around a portion where a component support portion is formed.

Another object of the present disclosure is to use an in-lamp structure provided in the empty space for improving the rigidity of the lamp body.

Another object of the present disclosure is to improve the rigidity of the lamp body by devising the shape of the lamp body.

Another object of the present disclosure is to provide a vehicle lamp including a lamp body that is thin and lightweight but that has sufficient rigidity, and that facilitates positioning of an attachment component.

Another object of the present disclosure is to provide a vehicle lamp that includes a lamp body including an engaging portion with which an engaged member is engaged and that can be reduced in weight.

### Solution to Problem

An aspect of a vehicle lamp according to the present disclosure including:
a lamp body having an opening in a front surface of the lamp body; and
a front lens that is attached to the opening in the front surface of the lamp body and that forms a lamp chamber inside the lamp body,
in which the lamp body includes, inside the lamp chamber:
   a component support portion; and
   a semi-cylindrical portion having a semi-cylindrical shape in cross section and surrounding both sides of the component support portion.

The bending stress generated in the component support portion of the lamp body in the direction inclined with respect to the extending direction of the semi-cylindrical portion due to the weight of the fixedly supported component is reduced by the semi-cylindrical portion that is in contact with and surrounds both sides of the component support portion.

A vehicle lamp according to another aspect of the present disclosure including: a container-shaped lamp body whose front surface is opened; a front cover that is assembled to a front opening of the lamp body and that defines a lamp chamber inside; and an in-lamp structure provided in the lamp chamber, in which a plurality of beams having a substantially arc shape in cross section and formed by a part of a container surface of the lamp body extend in a truss shape on the container surface, and in which the in-lamp structure is supported by at least one of the beams.

According to the present aspect, since the in-lamp structure is supported by at least one of the beams of the truss structure formed in the lamp body, the rigidity of the in-lamp structure becomes a part of the rigidity of the beam to reinforce the beam, and the strength of the truss structure is improved. The rigidity of the truss structure is increased, so that the thickness and the weight of the lamp body can be reduced.

A vehicle lamp according to another aspect of the present disclosure including: a container-shaped lamp body whose front surface is opened; and a front cover that is assembled to a front opening of the lamp body and that defines a lamp chamber inside, in which, when the lamp body is viewed in a cross section along a certain direction, the cross section is formed such that unevenness is continuous.

A vehicle lamp according to another aspect of the present disclosure including: a lamp body on which a lamp component is mounted; and a front lens that is attached to an opening in the lamp body, and that forms a lamp chamber inside the lamp body, in which the lamp body includes a plurality of protruding portions that have a bottomed tubular shape and that are integrally molded so as to protrude to either an inside or an outside of the lamp chamber and whose base end portions are opened, and in which the plurality of protruding portions are formed to be in contact with an outer periphery of the lamp component.

According to this aspect, the plurality of bottomed tubular protruding portions, which are integrally molded with the lamp body such that the base end portions are opened and protrude to either the outside or the inside of the lamp chamber, improve the rigidity of the lamp body without increasing the weight. The plurality of protruding portions are in contact with the outer periphery of the lamp component, thereby restricting the movement in the contact direction.

A vehicle lamp according to another aspect of the present disclosure including: a container-shaped lamp body having a front opening; and a front cover that is assembled to the front opening of the lamp body and that defines a lamp chamber inside, in which the lamp body includes an engaging portion with which an engaged member is engaged, and in which at least a part of the engaging portion constitutes a part of a wall surface of the lamp body.

According to this aspect, the engaging portion can be directly engaged with the wall surface of the lamp body at the time of engagement, it is not necessary to use an engaging component, and the weight of the vehicle lamp can be reduced.

### Advantageous Effects of Invention

According to the vehicle lamp in the present disclosure, since the rigidity against the bending stress generated in the forming portion of the component support portion of the lamp body is improved according to the weight of the mounted component without providing the rib, the weight of the vehicle lamp can be reduced.

### BRIEF DESCRIPTION OF DRAWINGS

FIG. 1 is a front view of a vehicle lamp according to an embodiment (the detailed form of a lamp body is omitted).

FIG. 2 is a schematic front view of the lamp body.

FIG. 3A is an enlarged front view of a region H showing the vicinity of a component support portion and a semi-cylindrical portion of the lamp body in FIG. 1.

FIG. 3B is an enlarged perspective view of the region H of the lamp body as viewed obliquely from the rear right and from below.

FIG. 4A is an enlarged perspective view of the region H of the lamp body including an aiming member as viewed obliquely from the front left and from above.

FIG. 4B is an enlarged perspective view of the region H of the lamp body from which the aiming member is removed, as viewed obliquely from the front left and from above.

FIG. 5A is a plan view of an end view of a second semi-cylindrical portion in FIG. 3A cut vertically at a position I-I.

FIG. 5B is an end view of a pair of second semi-cylindrical portions and the component support portion in FIG. 3A cut vertically along the left-right direction.

FIG. 6 is a schematic front view of a vehicle lamp according to an embodiment of the present disclosure.

FIG. 7 is a schematic front view of a lamp body of a lamp 1.

FIG. 8A is an end view of the lamp body in FIG. 7, which is an end view taken along a line A-A.

FIG. 8B is an end view of the lamp body in FIG. 7, which is an end view taken along a line B-B.

FIG. 8C is an end view of the lamp body in FIG. 7, which is an end view taken along a line C-C.

FIG. 8D is an end view of the lamp body in FIG. 7, which is an end view taken along a line D-D.

FIG. 8E is an end view of the lamp body in FIG. 7, which is an end view taken along a line E-E.

FIG. 8F is an end view of the lamp body in FIG. 7, which is an end view taken along a line F-F.

FIG. 8G is an end view of the lamp body in FIG. 7, which is an end view taken along a line G-G.

FIG. 9 is a diagram showing a truss structure formed in the lamp body in FIG. 7.

FIG. 10 is an enlarged view of a portion H in FIG. 7.

FIG. 11 is a diagram in which a LDM is provided in the portion H in FIG. 10.

FIG. 12 is a plan view of FIG. 11.

FIG. 13 is a diagram showing a vehicle lamp according to a first modification of the embodiment.

FIG. 14 is a diagram showing a vehicle lamp according to a second modification of the embodiment.

FIG. 15 is a schematic front view of a vehicle lamp according to an embodiment of the present disclosure.

FIG. 16 is a schematic front view of the lamp body of the vehicle lamp.

FIG. 17A is an end view taken along a line A-A of the lamp body in FIG. 16.

FIG. 17B is an end view taken along a line B-B of the lamp body in FIG. 16.

FIG. 17C is an end view taken along a line C-C of the lamp body in FIG. 16.

FIG. 17D is an end view taken along a line D-D of the lamp body in FIG. 16.

FIG. 17E is an end view taken along a line E-E of the lamp body in FIG. 16.

FIG. 17F is an end view taken along a line F-F of the lamp body in FIG. 16.

FIG. 18 is a diagram showing a truss structure formed in the lamp body in FIG. 16.

FIG. 19 is a rear view of the portion H of the lamp body shown in FIG. 16.

FIG. 20 is a rear perspective view of the portion H of the lamp body shown in FIG. 16.

FIG. 21 is a plan view of the portion H of the lamp body shown in FIG. 16.

FIG. 22 is an end view taken along a line J-J shown in FIG. 19.

FIG. 23 is a front view of the vehicle lamp according to the embodiment (the detailed form of the lamp body is omitted).

FIG. 24 is a schematic front view of the lamp body.

FIG. 25A is an enlarged front view of a region H1 showing a plurality of bottomed tubular protruding portions of the lamp body in FIG. 23.

FIG. 25B is an enlarged front view showing a state in which a lamp component is provided on a plurality of protruding portions in the region H1.

FIG. 26A is an enlarged perspective view of the region H1 of the lamp body as viewed obliquely from the front left.

FIG. 26B is an enlarged perspective view of a state in which the lamp component is provided on the plurality of protruding portions in the region H1 as viewed from the front left.

FIG. 27A is an end view obtained by cutting FIG. 25B substantially vertically at the position I-I.

FIG. 27B is an end view obtained by cutting FIG. 25B substantially horizontally at a position II-II.

FIG. 28A is an enlarged front view of a region H2 showing a plurality of bottomed tubular protruding portions of the lamp body in FIG. 23 as viewed obliquely from the front left and from above.

FIG. 28B is an enlarged front view of the region H2 showing the plurality of bottomed tubular protruding portions of the lamp body in FIG. 23 as viewed obliquely from the rear right and from above.

FIG. 29A is an enlarged front view of the region H2 in FIG. 23.

FIG. 29B is an end view obtained by cutting FIG. 29A at a position III-III.

FIG. 29C is an end view obtained by cutting FIG. 29A at a position IV-IV.

FIG. 30 is a schematic front view of a vehicle lamp according to an embodiment of the present disclosure.

FIG. 31 is a schematic front view of the lamp body of the vehicle lamp.

FIG. 32A is an end view taken along a line A-A of the lamp body in FIG. 31.

FIG. 32B is an end view taken along a line B-B of the lamp body in FIG. 31.

FIG. 32C is an end view taken along a line C-C of the lamp body in FIG. 31.

FIG. 32D is an end view taken along a line D-D of the lamp body in FIG. 31.

FIG. 33 is a diagram showing a truss structure formed in the lamp body in FIG. 31.

FIG. 34A is a front view of the portion H shown in FIG. 31. A state (before engagement) is shown in which only the lamp body is provided and in which the engaged member is not engaged.

FIG. 34B is a front view of the portion H shown in FIG. 31. A state (after engagement) is shown in which the engaged member is engaged with the lamp body.

FIG. 35A shows the lamp body of the portion H shown in FIG. 31, and is a front perspective view of the portion H.

FIG. 35B shows the lamp body of the portion H shown in FIG. 31, and is a rear perspective view of the portion H.

FIG. 36 is an exploded perspective view of the portion H shown in FIG. 31.

FIG. 37A is an end view taken along a line H-H shown in FIG. 34A.

FIG. 37B is an end view taken along a line G-G shown in FIG. 34A.

FIG. 38A is an end view taken along a line J-J shown in FIG. 34A, and shows a process in which the engaged member engages with the lamp body.

FIG. 38B is an end view taken along the line J-J shown in FIG. 34A, and shows the process in which the engaged member engages with the lamp body.

FIG. 39A is an end view taken along the line J-J shown in FIG. 34A, and shows another process in which the engaged member engages with the lamp body.

FIG. 39B is an end view taken along the line J-J shown in FIG. 34A, and shows another process in which the engaged member engages with the lamp body.

FIG. 39C is an end view taken along the line J-J shown in FIG. 34A, and shows another process in which the engaged member engages with the lamp body.

### DESCRIPTION OF EMBODIMENTS

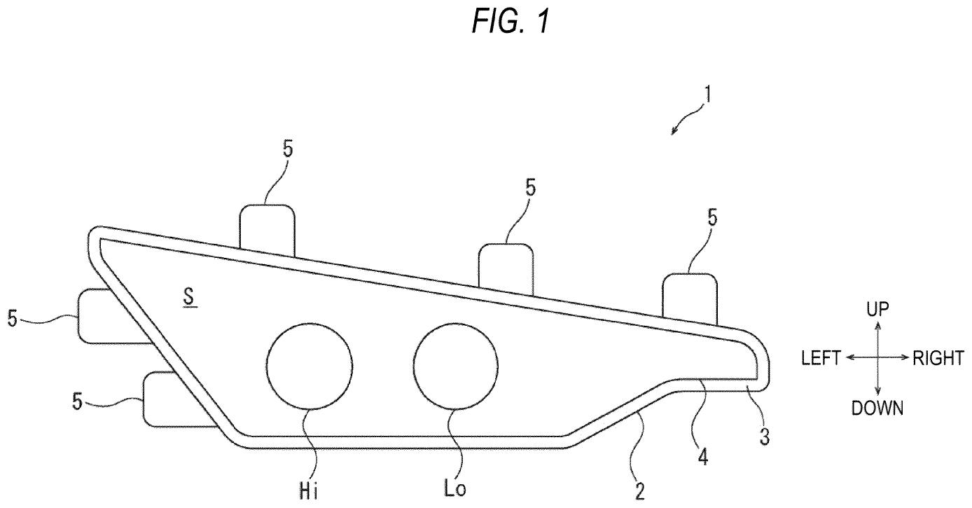

Hereinafter, a preferred embodiment of a vehicle lamp of the present disclosure will be described with reference to FIGS. 1 to 5. The embodiment is exemplary only without limiting the invention, and all or combinations of the features described in the embodiment are not necessarily essential to the invention. In the following description of the embodiment and the modification, the same configurations are denoted by the same reference signs, and the overlapping description thereof will be appropriately omitted. In the drawings, the directions of the vehicle lamp are described as (front: rear: left: right: upper: lower).

FIG. 1 is a front view of a vehicle lamp 1 according to the preferred embodiment of the present disclosure. The vehicle lamp 1 in FIG. 1 includes a lamp body 2, a front lens 4, and a plurality of brackets 5 for attaching the lamp body 2 to the vehicle body. The lamp body 2 is made of resin or the like, has a container shape in a vertical cross section along the front-rear direction, with a back wall extending in the upper-lower direction and a bottom wall extending in the front-rear direction, and has an opening at the front end thereof. As indicated by a reference sign 3 in the drawings, a groove-shaped seal portion 3 recessed rearward is provided on the entire circumference of the opening of the front surface of the lamp body 2. The front lens 4 is made of a light-transmitting material such as resin or glass, is fixed to the seal portion 3, and defines a lamp chamber S sealed inside the lamp body 2.

A high beam lamp unit Hi and a low beam lamp unit Lo are accommodated in the defined lamp chamber S shown in FIG. 1, both of which emit headlight forward (toward the viewer on the page). The high beam lamp unit Hi and the low beam lamp unit Lo are optical units that irradiate the front of the vehicle with light emitted from a light source to form a high beam light distribution or a low beam light distribution. The lamp units (Hi and Lo) have a known configuration in the related art, such as a reflective type or a projector type lamp unit, and the type thereof does not matter.

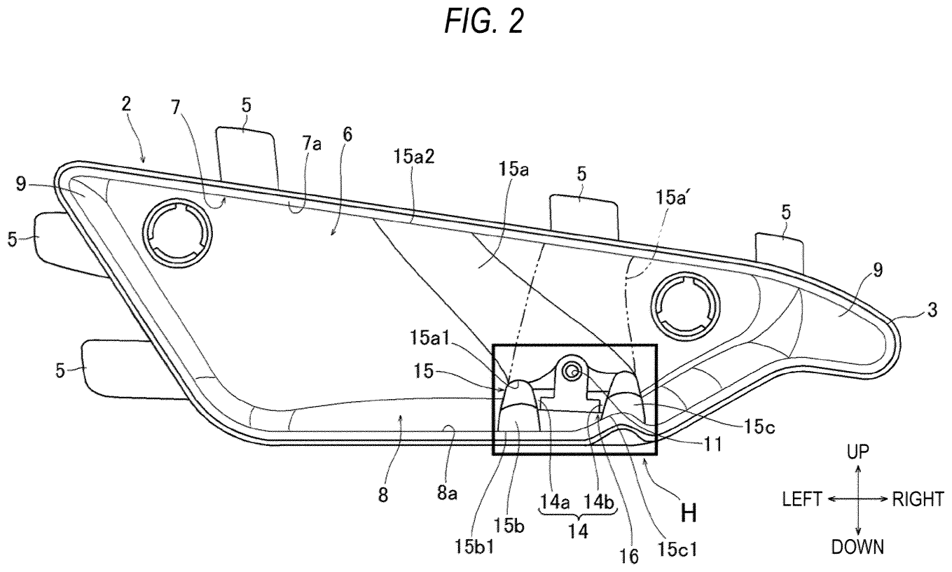

Next, the shape of the lamp body 2 will be described in detail. FIG. 2 is a schematic front view of the lamp body 2. The lamp body 2 is molded by injection molding using a hard synthetic resin material.

The lamp body 2 includes a back wall 6, a ceiling surface 7, a bottom surface 8, and left and right side surfaces 9 and 9 as constituent surfaces. The back wall 6 bulges rearward and is continuously connected in a curved manner to the adjacent ceiling surface 7, bottom surface 8, and side surfaces 9 and 9 via the ridge lines. The ceiling surface 7, the bottom surface 8, and the side surfaces 9 and 9 basically have a convex curved shape that gently bulges toward the outside of the lamp body 2, are gently curved at the edge portions thereof, and are continuously coupled without any bent portions or steps. Therefore, the lamp body 2 is formed in a rounded container shape as a whole.

The bottom surface 8 shown in FIG. 2 extends forward from the lower edge portion of the back wall 6, and is connected to the seal portion 3 provided at the edge portion of the opening of the front surface of the lamp body 2. The side surfaces 9 extend from the left and right edge portions of the back wall 6 toward the lateral sides and slightly forward, and are connected to the seal portion 3. The ceiling surface 7 has a small extension amount, extends from the edge portion of the seal portion 3 while gently curving rearward and downward, is connected to the back wall 6, and is formed substantially integrally with the back wall 6.

Therefore, the back wall 6, the ceiling surface 7, the bottom surface 8, and the side surfaces 9 and 9 are not mainly flat but are curved surfaces having a large curvature radius, the lamp body 2 as a whole is formed in a container shape with the back wall 6 as a bottom portion, and each of the back wall 6, the ceiling surface 7, the bottom surface 8, and the side surface 9 and 9 forms a container surface in which curved surfaces are smoothly continuous with each other.

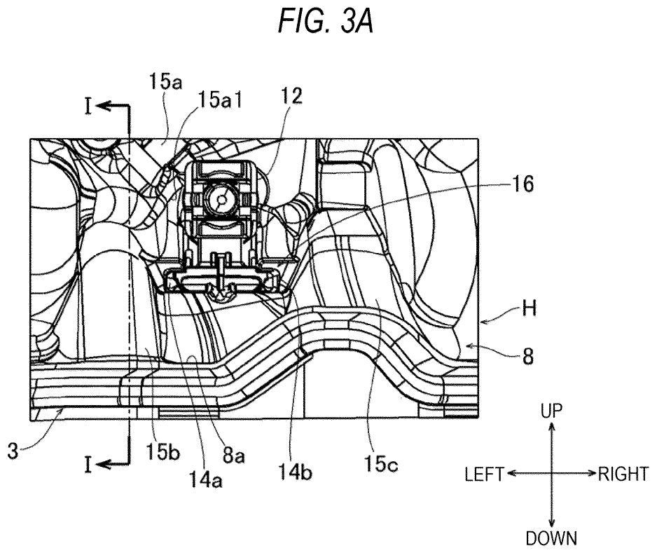

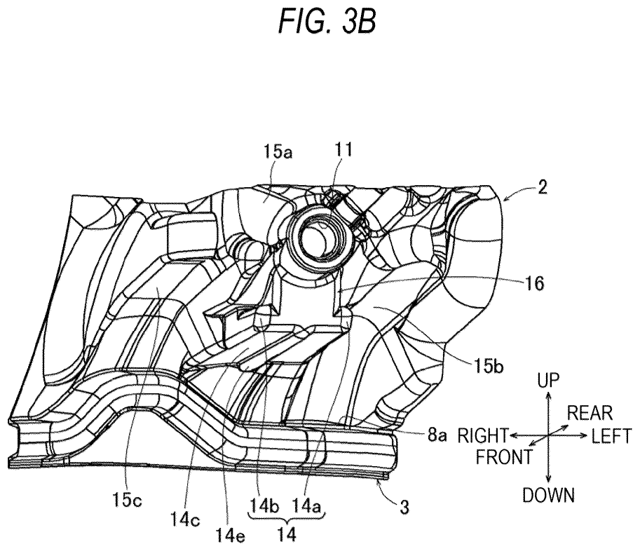

As shown in FIG. 2, the lamp body 2 is provided with three attachment holes 11 (the other two are not shown) for attaching an aiming member 12 constituting an aiming mechanism, and slide support portions 14 provided corresponding thereto. The attachment hole 11 serving as the first component support portion and the slide support portion 14 jointly constitute a component support portion 16, and the aiming member 12 shown in FIGS. 3A, 4A, and 5B is attached thereto.

Next, the detailed form of the peripheral region of the component support portion 16 will be described with reference to FIGS. 2 to 5A and 5B.

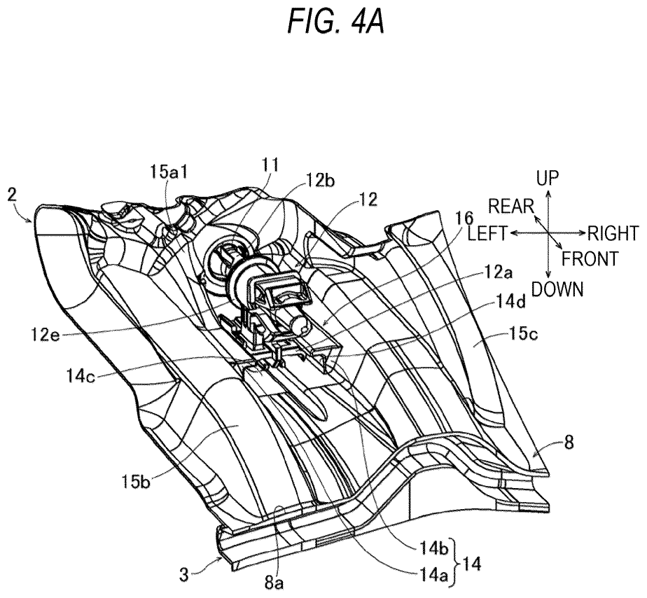

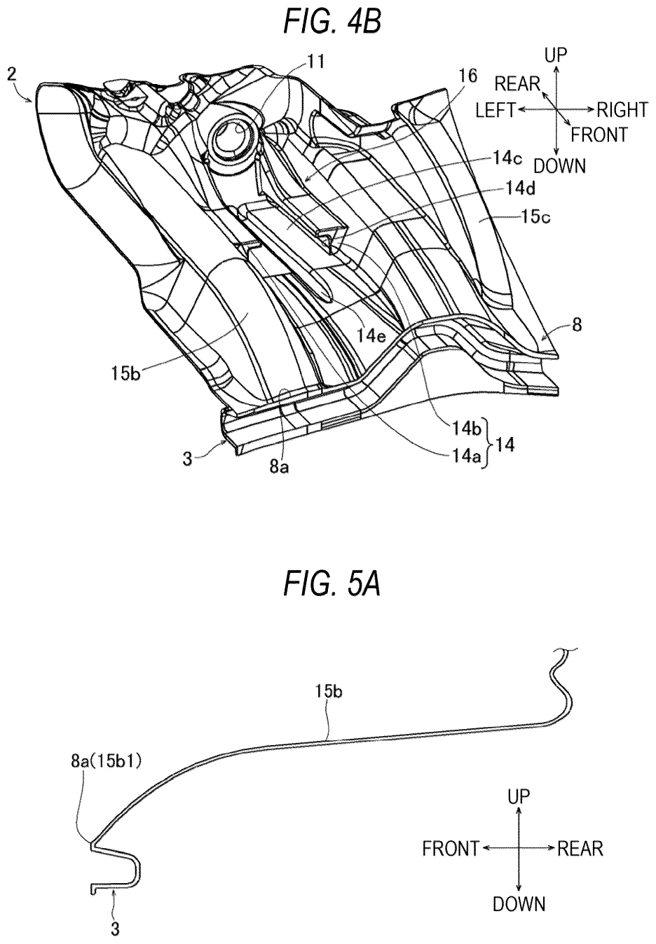

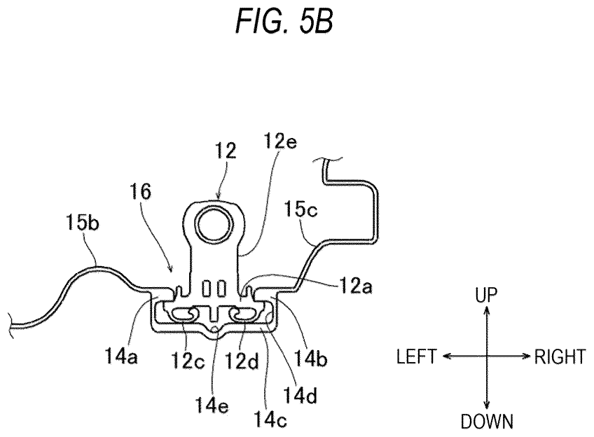

A reference sign H in FIG. 2 denotes a schematic view A regarding the peripheral region of a first semi-cylindrical portion 15a, second semi-cylindrical portions 15b and 15c, and a component support portion 16 to be described later, and FIG. 3A is an enlarged front view A of the region H. FIGS. 3A, 4A, and 4B are partial perspective views of the peripheral region of the second semi-cylindrical portions 15b and 15c and the component support portion 16 of the lamp body 2 viewed from various directions, and FIG. 5A is an end view of the second semi-cylindrical portion 15b cut perpendicularly (vertically) along the front-rear direction. FIG. 5B is a cross-sectional view of the second semi-cylindrical portions 15b and 15c and the component support portion 16 to which the aiming member 12 is attached, perpendicularly (vertically) cut along the left-right direction.

As shown in FIGS. 2, 4A, and 5B, the slide support portion 14 constituting the component support portion 16 includes a left end portion 14a, a right end portion 14b, and a bottom portion 14c. The left end portion 14a and the right end portion 14b are integrally formed so as to extend upward from both left and right end portions of the bottom portion 14c, the upper end of the left end portion 14a is bent rightward, and the upper end of the right end portion 14b is bent inward so as to face the upper end portion of the left end portion 14a. A reference sign 14d denotes a slide groove formed on the inside of the left end portion 14a, the right end portion 14b, and the bottom portion 14c. As shown in FIGS. 4A and 5B, a recessed groove 14e extending in the front-rear direction and recessed downward is formed at the center of the bottom portion 14c, and the attachment hole 11 is formed above the recessed groove 14e.

As shown in FIGS. 4A and 5B, the aiming member 12 includes a flat plate-shaped pedestal portion 12a, a main body portion 12e integrally formed above the pedestal portion 12a, and a pair of left and right spring portions 12c and 12d. The pair of left and right spring portions 12c and 12d are springs that are integrally formed so as to face the left and right lower end portions of the pedestal portion 12a, that extend obliquely downward from the pedestal portion 12a, and that generate a downward biasing force by being bent upward.

As shown in FIG. 4A, the aiming member 12 is attached to the component support portion 16 by inserting a base end portion 12b into the attachment hole 11 of the lamp body 2 and inserting the pedestal portion 12a into the slide groove 14d of the slide support portion 14 in a state in which the spring portions 12c and 12d are bent upward as shown in FIG. 5B. The base end portion 12b of the aiming member 12 is engaged with and supported on the attachment hole 11. The pedestal portion 12a is configured to receive an upward biasing force by the spring portions 12c and 12d in contact with the bottom portion 14c, and is biased to the upper end portions of both the left end portion 14a and the right end portion 14b of the slide support portion. The aiming member 12 is fixed to the component support portion 16 of the lamp body 2 by supporting the base end portion 12b in the peripheral region of the attachment hole 11 and sandwiching the pedestal portion 12a between the left and right end portions 14a and 14b and the bottom portion 14c of the slide support portion 14 via the spring portions 12c and 12d.

As shown in FIG. 2, around the component support portion 16 of the lamp body 2, the first semi-cylindrical portion 15a that extends obliquely upward to the left from the periphery of the attachment hole 11 and the second semi-cylindrical portions 15b and 15c that surround the left and right of the attachment hole 11 and the slide support portion 14 are provided. As shown in FIG. 2 to A FIG. 5, the first semi-cylindrical portion 15a is formed on the back wall 6, and has a curved semi-cylindrical dome shape in which the perpendicular end surface (the transverse cross section) with respect to the extending direction thereof is convex toward the front. The second semi-cylindrical portions 15b and 15c are formed on the bottom surface 8, and have a curved semi-cylindrical dome shape in which the perpendicular end surface (the transverse cross section) with respect to the extending direction thereof is convex upward as shown in FIG. 2 to A FIG. 4, and particularly in FIG. 5B.

As shown in FIG. 2, the upper end portion of the first semi-cylindrical portion 15a is a part of the seal portion 3 (the opening of the front surface of the lamp body) of the lamp body 2 and is formed continuously with a seal portion 7a located on the ceiling surface 7, and the pair of second semi-cylindrical portions 15b and 15c are formed to offset from a lower end portion 15a1 of the first semi-cylindrical portion 15a in the left-right width direction while maintaining the unity with the first semi-cylindrical portion 15a. Lower end portions 15b1 and 15c1 of the pair of second semi-cylindrical portions 15b and 15c are formed continuously with the seal portion 8b that is a part of the seal portion 3 (the opening of the front surface of the lamp body) of the lamp body 2 and that is located on the bottom surface 8 facing the ceiling surface 7 (see FIG. 5A). The second semi-cylindrical portion 15b is integrally formed so as to come into contact with the left end portion 14a of the slide support portion 14, and the second semi-cylindrical portion 15c is integrally formed so as to come into contact with the right end portion 14b.

As shown in FIG. 2 to A FIG. 4, in the attachment hole 11 and the slide support portion 14 in the component support portion 16, the bending stress generated in a direction inclined with respect to the front-rear direction in which the second semi-cylindrical portions 15b and 15c extend is reduced by the second semi-cylindrical portions 15b and 15c provided in the lamp body 2 so as to surround both left and right sides thereof. As a result, even if the bending stress due to an increase in the weight of a component such as the aiming member 12 is generated in the component support portion 16 to be mounted, sufficient rigidity against the bending stress can be attained without providing an integral rib around the attachment hole 11 or at the lower end portion of the slide support portion 14 as in the related art, and thus the weight of the lamp body 2 and the vehicle lamp 1 can be reduced by omitting the rib. The second semi-cylindrical portions 15b and 15c are integrally formed so as to come into contact with the slide support portion 14, so that it is possible to achieve higher rigidity against the bending stress in the slide support portion 14 than when the second semi-cylindrical portions 15b and 15c are formed away from the slide support portion 14.

As shown in FIG. 2, the first semi-cylindrical portion 15a and the second semi-cylindrical portions 15b and 15c formed continuously and integrally with the first semi-cylindrical portion 15a are formed continuously from the portion 7a of the seal portion 3 (the opening of the front surface of the lamp body) on the ceiling surface 7 to a portion 8a of the seal portion 3 on the facing bottom surface 8. In this way, one end of the semi-cylindrical portion integrally formed by the first semi-cylindrical portion 15a and the second semi-cylindrical portions 15b and 15c formed around the component support portion 16 is continuously formed on the seal portion 3 of the ceiling surface 7, and the other end is continuously formed on the seal portion 3 of the bottom surface facing the ceiling surface 7. Accordingly, in the lamp body 2, not only the rigidity against bending around the formation portion of the component support portion 16 of the bottom surface 8 can be improved by the second semi-cylindrical portions 15b and 15c surrounded from both sides, but also high rigidity against the bending stress generated in a direction inclined with respect to the extending direction of the first semi-cylindrical portion 15a and the second semi-cylindrical portions 15b and 15c can be attained in the entire region of the ceiling surface 7, the back wall 6, and the bottom surface 8.

As shown in FIGS. 2 to 5A and 5B, the first semi-cylindrical portion 15a and the second semi-cylindrical portions 15b and 15c are integrally formed with the seal portion 3, so that the bending stress generated in the lamp body 2 also acts on the front lens 4 via the seal portion 3. Therefore, the rigidity of the component support portion 16 can be further improved in both the lamp body 2 and the front lens.

As shown in FIG. 2, the first semi-cylindrical portion 15a is not limited to extending obliquely upward to the left from the vicinity of the component support portion 16. The first semi-cylindrical portion 15a may be continuous with any of the portions 7a of the seal portion 3 of the ceiling surface 7, and may be formed directly above the component support portion 16 as in a portion indicated by a reference sign 15a′ surrounded by a virtual line (a two-dot chain line). The second semi-cylindrical portions 15b and 15c may not be integrated with one first semi-cylindrical portion 15a, but may extend to the portion 7a of the seal portion 3 of the ceiling surface 7 as a pair.

### Vehicle Lamp

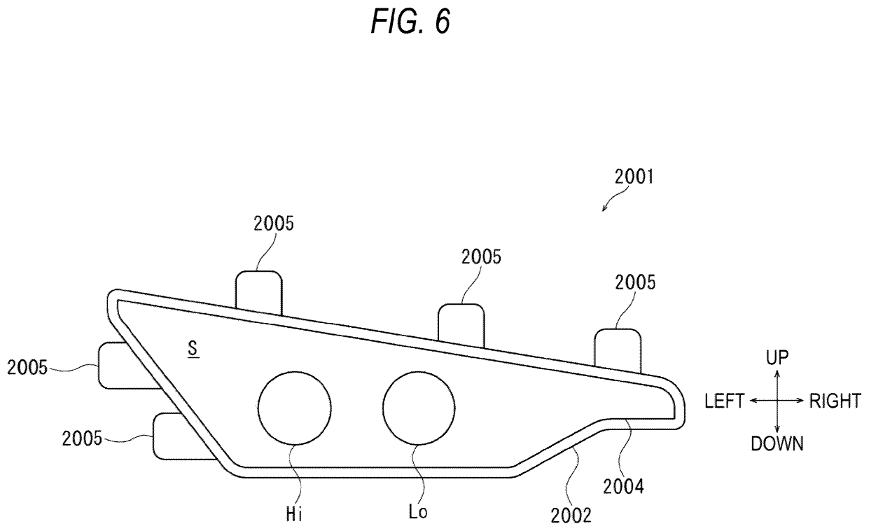

Next, a second embodiment of the present disclosure will be described with reference to FIGS. 6 to 14.

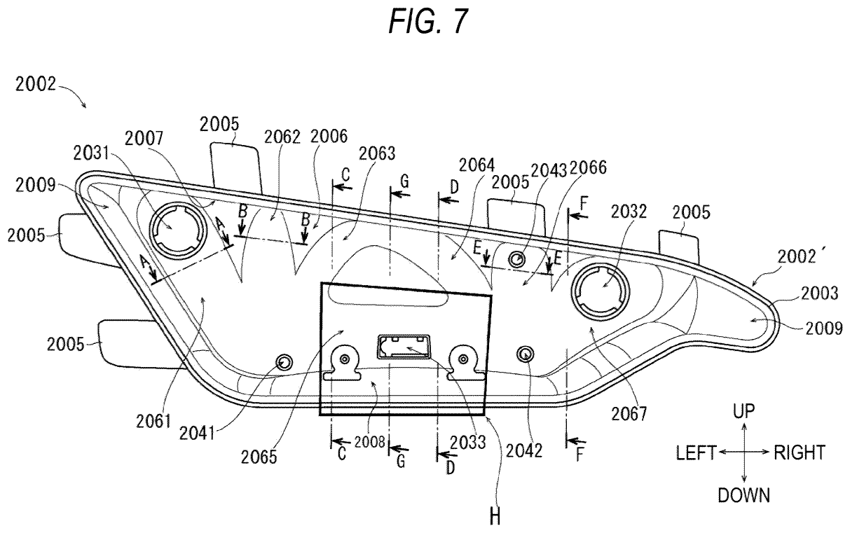

FIG. 6 is a schematic front view of a vehicle lamp 2001 according to the preferred embodiment of the present disclosure. The vehicle lamp 2001 is a headlamp that is mounted on the left and right corner portions of the front of a vehicle. As shown in FIG. 6, the vehicle lamp 2001 includes a container-shaped lamp body 2002 that is open at the front, and a front cover 2004 that is attached to a front opening 2002′ (see FIG. 7 to be described later) of the lamp body 2002. The front cover 2004 is made of a translucent resin such as polycarbonate or glass, and the front cover 2004 is attached to the front opening 2002′ of the lamp body 2002 to define the lamp chamber S inside.

The high beam lamp unit Hi and the low beam lamp unit Lo are accommodated in the defined lamp chamber S. The high beam lamp unit Hi and the low beam lamp unit Lo are optical units that irradiate the front of the vehicle with light emitted from a light source to form a high beam light distribution or a low beam light distribution. The lamp units (Hi and Lo) may have a known configuration in the related art, such as a reflective type or a projector type lamp unit, and the type thereof does not matter.

### Overall Shape of Lamp Body

The shape of the lamp body 2002 will be described in detail. FIG. 7 is a schematic front view of the lamp body 2002.

The lamp body 2002 is formed by injection molding using a hard synthetic resin material. A seal groove 2003 for engaging with a seal leg provided on the periphery of the front cover 2004 is provided around the periphery of the front opening 2002′ of the lamp body 2002. A vehicle body attachment portion 2005 for attachment to the vehicle body is provided so as to protrude from the outer surface of the peripheral portion of the front opening 2002′ of the lamp body 2002 in a manner of corresponding to the shape of the attachment portion on the vehicle body side. The vehicle body attachment portions 2005 are provided at a total of five locations on the outer surface of the lamp body 2002, three locations on the upper side and two locations on the left side.

The lamp body 2002 includes a back wall 2006, a ceiling surface 2007, a bottom surface 2008, and left and right side surfaces 2009 as constituent surfaces. The back wall 2006 bulges rearward and is continuously connected (in a curved manner) to the adjacent ceiling surface 2007, bottom surface 2008, and side surfaces 2009 via the ridge lines.

The bottom surface 2008 extends forward from the lower edge portion of the back wall 2006, and is connected to the seal groove 2003 formed at the edge portion of the front opening 2002′ of the lamp body 2002. The side surfaces 2009 extend from the left and right edge portions of the back wall 2006 toward the lateral sides and slightly forward, and are connected to the seal groove 2003. The ceiling surface 2007 has a small extension amount, extends from the edge portion of the seal groove 2003 while gently curving downward and toward the back surface, is connected to the back wall 2006, and is formed substantially integrally with the back wall 2006.

Therefore, the back wall 2006, the ceiling surface 2007, the bottom surface 2008, and the side surface 2009 are not mainly flat but are curved surfaces having a large curvature radius, the lamp body 2002 as a whole is formed in a container shape with the back wall 2006 as a bottom portion, and each of the back wall 2006, the ceiling surface 2007, the bottom surface 2008, and the side surface 2009 forms a container surface in which curved surfaces are smoothly continuous with each other.

A first unit attachment hole 2031, a second unit attachment hole 2032, and a third unit attachment hole 2033 are formed in the lamp body 2002. The first unit attachment hole 2031 is a hole for attaching the high beam lamp unit Hi, and is formed in the upper left side of the back wall 2006. The second unit attachment hole 2032 is a hole for attaching a back cover (not shown), and is formed on the upper right side of the back wall 2006. The third unit attachment hole 2033 is a hole for attaching a light driver module 2050 (to be described later; hereinafter referred to as LDM) that controls lighting of the lamp units (Hi, Lo), and is formed in the central lower portion of the back wall 2006.

In the lamp body 2002, a first aiming member attachment hole 2041, a second aiming member attachment hole 2042, and a third aiming member attachment hole 2043 are formed around the third unit attachment hole 2033. An aiming member (not shown) having a known configuration in the related art is attached to the aiming member attachment holes 2041, 2042, and 2043. The first aiming member attachment hole 2041 is formed in the left lower edge portion of the back wall 2006 so as to be formed between the third unit attachment hole 2033 and the first unit attachment hole 2031. The second aiming member attachment hole 2042 is formed in the right lower edge portion of the back wall 2006 so as to be offset from the first aiming member attachment hole 2041 in the opposite direction by approximately the same distance as the distance from the third unit attachment hole 2033 to the first aiming member attachment hole 2041. The third aiming member attachment hole 2043 is formed in the right upper end portion of the back wall 2006 so as to be formed substantially vertically above the second aiming member attachment hole 2042.

### Beam Structure of Lamp Body

On the back wall 2006 of the lamp body 2002, a first beam 2061, a second beam 2062, a third beam 2063, a fourth beam 2064, a fifth beam 2065, a sixth beam 2066, and a seventh beam 2067, which are parts of the back wall 2006, extend over substantially the entire back wall 2006. The first beam 2061 extends so as to connect the first aiming member attachment hole 2041 and the first unit attachment hole 2031 as end points, and is formed as a beam inclined to the left. The second beam 2062 extends substantially upward from the first aiming member attachment hole 2041 to the upper end portion of the back wall 2006, and is formed as a beam extending in the substantially vertical direction. The third beam 2063 extends so as to connect the first aiming member attachment hole 2041 and the upper central end portion of the back wall 2006 as end points, and is formed as a beam inclined to the right. The fourth beam 2064 extends so as to connect the upper central end portion of the back wall 2006 described above and the second aiming member attachment hole 2042 as end points, and is formed as a beam inclined to the left. The fifth beam 2065 extends so as to connect the first aiming member attachment hole 2041 and the second aiming member attachment hole 2042 as end points, and is formed as a beam extending in the substantially horizontal direction. The sixth beam 2066 extends so as to connect the second aiming member attachment hole 2042 and the third aiming member attachment hole 2043 as end points, and is formed as a beam extending in the substantially vertical direction. The seventh beam 2067 extends so as to connect the second aiming member attachment hole 2042 and the second unit attachment hole 2032 as end points, and is formed as a beam inclined to the right.

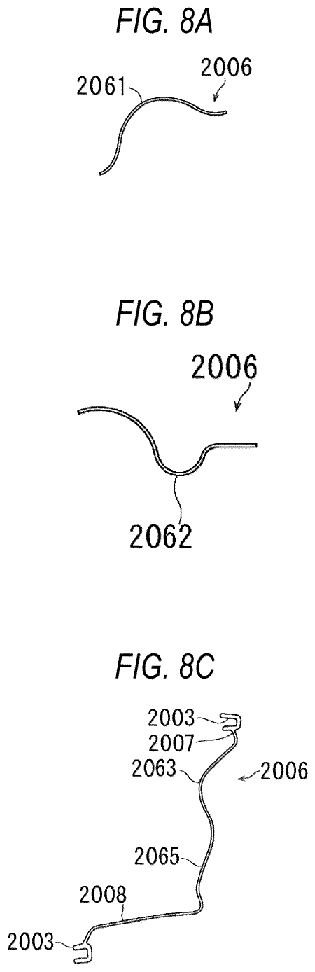

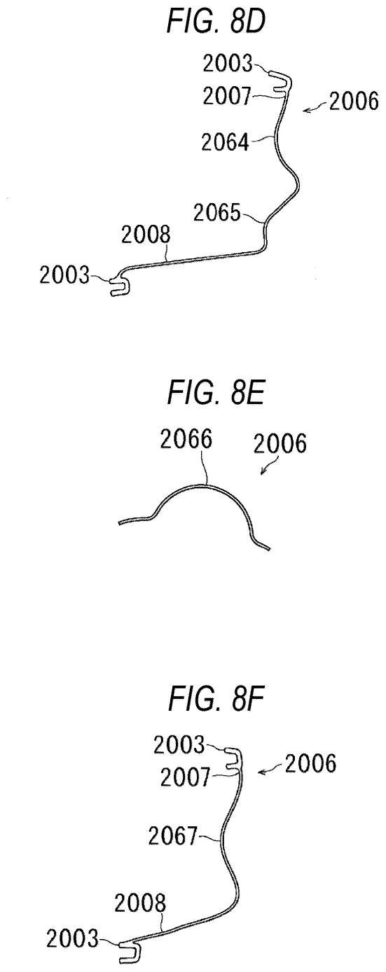

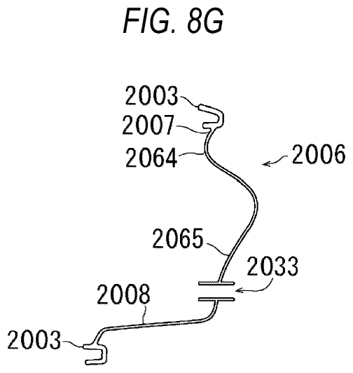

FIGS. 8A to 8G are end views of the beams 2061 to 2067 along the cutting line shown in FIG. 7. FIG. 8A is an end view taken along a line A-A and shows the cross-sectional shape of the first beam 2061. FIG. 8B is an end view taken along a line B-B and shows the cross-sectional shape of the second beam 2062. FIG. 8C is an end view taken along a line C-C, in which the upper side is the cross-sectional shape of the third beam 2063, and the lower side is the cross-sectional shape of the left end portion of the fifth beam 2065. FIG. 8D is an end view taken along a line D-D, in which the upper side is the cross-sectional shape of the fourth beam 2064, and the lower side is the cross-sectional shape of the right end portion of the fifth beam 2065. FIG. 8E is an end view taken along a line E-E and shows the cross-sectional shape of the sixth beam 2066. FIG. 8F is an end view taken along a line F-F and shows the cross-sectional shape of the seventh beam 2067. FIG. 8G is an end view taken along a line G-G, in which the upper side is the cross-sectional shape of the fourth beam 2064, and the lower side is the cross-sectional shape of the central portion of the fifth beam 2065. The third unit attachment hole 2033 is formed in the central portion of the fifth beam 2065. In this way, each of the beams 2061 to 2067 is implemented such that the cross-sectional shape orthogonal to the extending direction thereof is a substantially arc shape. The protruding direction of the curved surface of each of the beams 2061 to 2067 may be formed in either the direction (forward) toward the lamp chamber S or the outward direction (rearward) of the lamp chamber S. In the present embodiment, each of the beams 2061 to 2067 is formed as a beam curved in the direction (forward) toward the lamp chamber S.

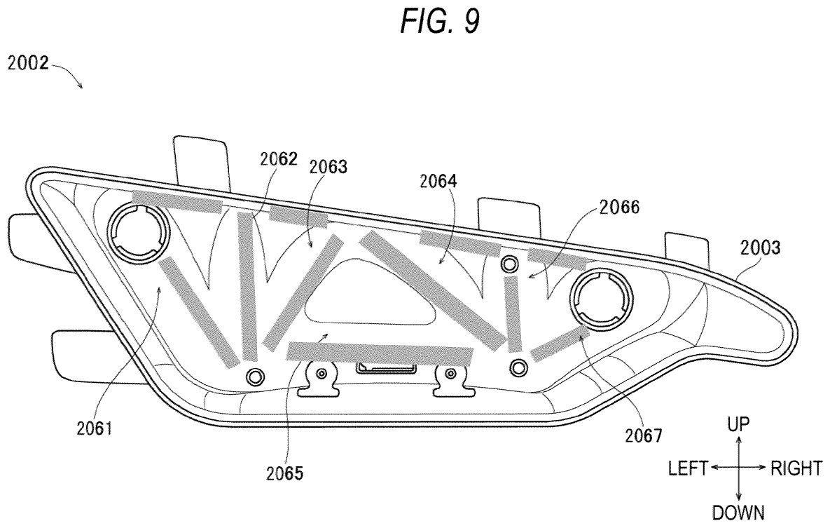

Here, FIG. 9 is a front view of the lamp body 2002, in which the truss structure formed in the lamp body 2002 is shown in light ink. As described above, since the ceiling surface 2007 is substantially integrated with the back wall 2006, the seal groove 2003 of the ceiling surface 2007 extends like the upper chord member of a truss. In the lamp body 2002, the truss structure shown in FIG. 9 is formed by connecting the force application points by the beams 2061 to 2067 and the seal groove 2003 of the ceiling surface 2007.

Therefore, the lamp body 2002 according to the present embodiment has a structure having higher rigidity than a lamp body that does not have such a truss structure.

### Use of In-Lamp Structure

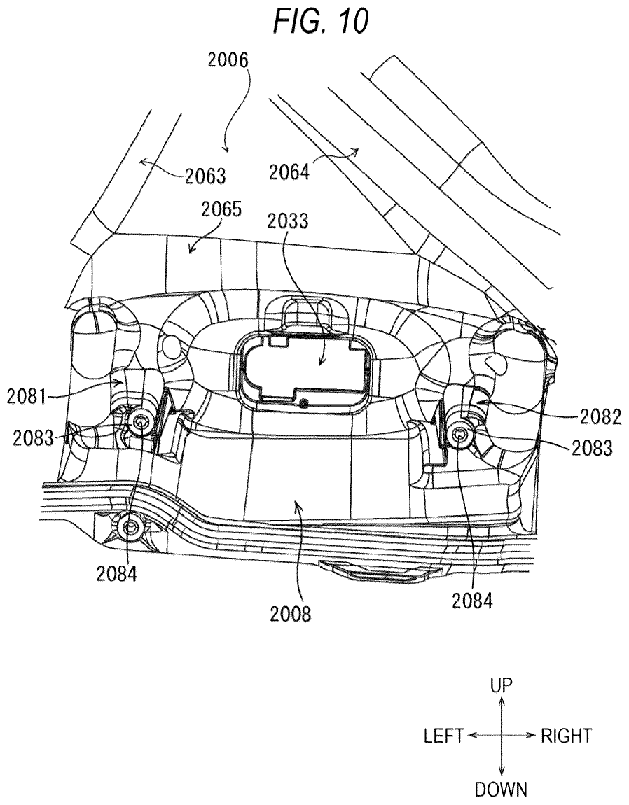

As the rigidity of the truss structure described above increases, the lamp body 2002 can be made thinner than that in the related art, and the weight can be reduced. A structure for this will be described in detail with reference to FIGS. 10 to 12.

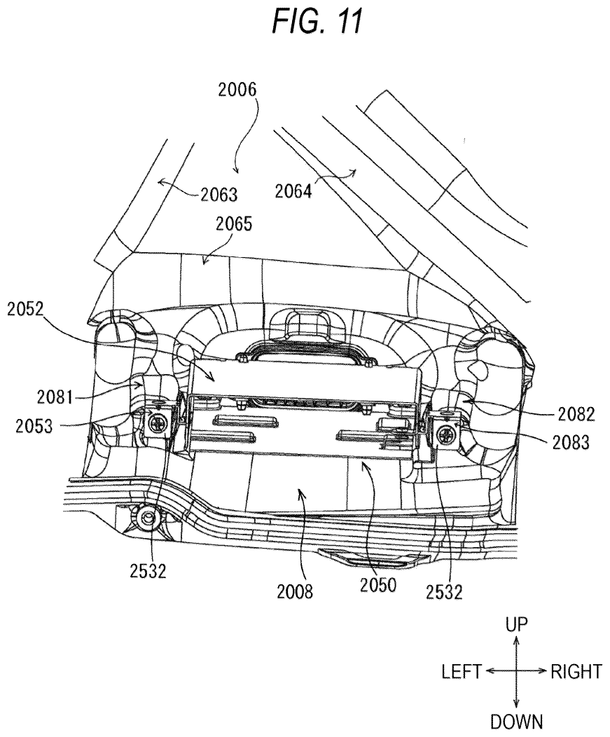

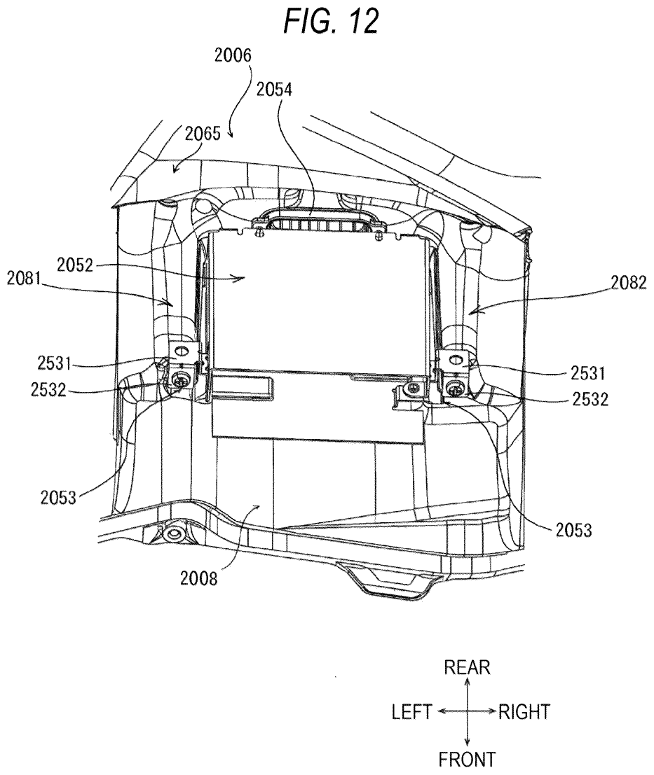

FIG. 10 is an enlarged view of a portion H in FIG. 7, FIG. 11 is a view in which the LDM 2050 is provided in the portion H, and FIG. 12 is a plan view of FIG. 11. As shown in FIGS. 8C, 8D, and 8G, the fifth beam 2065 is implemented by a curved surface that is convex in the direction (forward) toward the lamp chamber S, and as shown in FIG. 10, the third unit attachment hole 2033 is formed in the central portion of the fifth beam 2065. As shown in FIG. 11, the LDM 2050 is fixed to the third unit attachment hole 2033.

The light driver module (LDM) 2050 is one of the in-lamp structures. In the present specification, the in-lamp structure is a structure provided in the lamp chamber S, and refers to a component, a member, or a unit that needs to be provided in the lamp chamber S, such as a lighting control unit of a lamp unit such as the LDM 2050, and a swivel drive control unit or a leveling drive control unit of the lamp unit, and that has a predetermined size and strength.

The LDM 2050 includes a lighting control circuit and an electronic control unit (ECU) on a substrate (not shown), and includes a metal case 2052 surrounding the substrate. The metal case 2052 has a rectangular parallelepiped shape, and in a fixed state, the lower surface extends slightly beyond the upper surface and the front side is open. The back surface side of the metal case 2052 is a connector insertion port 2054 (see FIG. 12). The connector insertion port 2054 has a shape corresponding to the unevenness shape formed in the third unit attachment hole 2033 in the peripheral portion, and is fitted into the third unit attachment hole 2033. The LDM 2050 is supported on the fifth beam 2065 by fitting the connector insertion port 2054 into the third unit attachment hole 2033.

On the left and right side surfaces of the metal case 2052, fixing portions 2053 integrally formed with the metal case 2052 are provided near the front end portion of the case upper surface. The fixing portion 2053 includes a first pressing plate 2531 formed in a stepped shape such that a plate extending from the left and right side surfaces in the horizontal direction is bent and offset upward, and a second pressing plate 2532 formed by bending the front side of the first pressing plate 2531 in the vertically downward direction, and a screw insertion hole (not shown) is formed in at least the second pressing plate 2532.

On the other hand, a pair of holding arms 2081 and 2082 for holding the LDM 2050 are formed on the left and right of the third unit attachment hole 2033. The holding arms 2081 and 2082 are separated by the length of the LDM 2050 in the left-right direction, and are formed such that the distances from the center of the third unit attachment hole 2033 are equal distances to each other. The holding arms 2081 and 2082 extend forward in a columnar shape from the back wall 2006, have a lower end portion connected to the bottom surface 2008, and are formed integrally with the bottom surface 2008. A front surface 2083 of the holding arms 2081 and 2082 is a vertical plane, extends forward to a position coinciding with the second pressing plate 2532 of the LDM 2050, and has a screw hole 2084.

The LDM 2050 is cantilever-supported by the fifth beam 2065 by fitting the connector insertion port 2054 into the third unit attachment hole 2033, and is fixed at three points by the third unit attachment hole 2033, the holding arm 2081, and the holding arm 2082 by screwing and fixing the second pressing plate 532 of the fixing portion 2053 to the front surface 2083 of the holding arms 2081 and 2082.

### Advantageous Effects

In the related art, based on the idea that an in-lamp structure such as an LDM may be attached somewhere in a lamp body, the in-lamp structure is provided in an empty space of the lamp body by, for example, forming a box-shaped accommodation space for supporting the case of the LDM. On the other hand, in the present embodiment, since the LDM 2050 (the in-lamp structure) is supported by the fifth beam 2065 (the truss structure) of the lamp body 2, the rigidity of the LDM 2050 (the in-lamp structure) becomes a part of the rigidity of the fifth beam 2065 to improve the strength of the fifth beam 2065.

In particular, in the truss structure formed in the lamp body 2 according to the present embodiment, since the fifth beam 2065 of the beams 2061 to 2067 is a compressed material, it is preferable that the fifth beam 2065 has higher rigidity. On the other hand, in the present embodiment, since the rigidity of the LDM 2050 becomes a part of the rigidity of the fifth beam 2065 and the rigidity can be improved in the compressed material of the truss structure, the resistance to the deformation and buckling of the truss structure formed in the lamp body 2002 can be improved.

The in-lamp structure preferably extends along the axial direction of the beam because the rigidity of the beam can depend on the rigidity of the in-lamp structure. On the other hand, in the present embodiment, the metal case 2052 of the LDM 2050 is longest in the left-right direction among the left-right direction, the front-rear direction, and the upper-lower direction in the fixed state, and the long side of the metal case 2052 is provided in the left-right direction which is the axial direction of the fifth beam 2065. Therefore, the LDM 2050 functions as a column in the fifth beam 2065, and thus the rigidity of the truss structure formed in the lamp body 2002 can be further improved.

It is preferable that the in-lamp structure is also coupled to a container surface different from the container surface including the beam supporting the in-lamp structure because the rigidity of the beam supporting the in-lamp structure can also depend on the rigidity of the different container surface via the in-lamp structure. On the other hand, in the present embodiment, the LDM 2050 is fixed at three points in which the LDM 2050 is coupled not only to the back wall 2006 (the container surface) including the fifth beam 2065 supporting the LDM 2050 but also to the holding arms 2081 and 2082 formed on the bottom surface 2008 (the different container surface) in the vicinity thereof. Therefore, the rigidity of the fifth beam 2065 is improved by the rigidity of the bottom surface 2008. Therefore, the rigidity of the fifth beam 2065 is improved, and the resistance to the deformation and buckling of the truss structure formed in the lamp body 2002 can be further increased.

### Modification

Next, preferred modifications of the embodiment described above will be described.

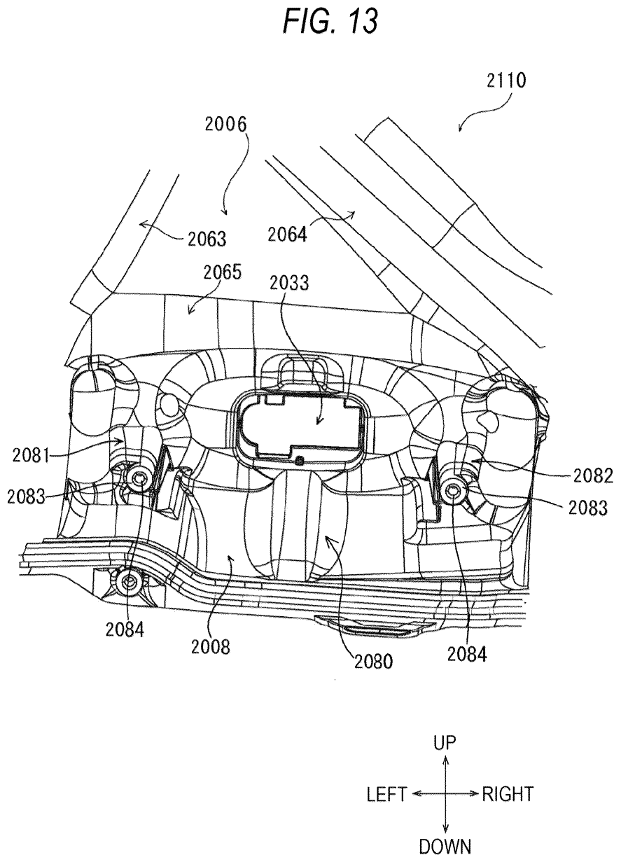

FIG. 13 shows a vehicle lamp 2110 according to a first modification, and is an enlarged view of the lamp 2110 similarly to FIG. 10. The fifth beam 2065 on which the LDM 2050 is provided is a relatively long beam among the other beams 2061 to 2064, 2066, and 2067. In such a long beam, it is preferable that the in-lamp structure is provided as described in the embodiment, and as described in the present modification, at least one undulation is formed in the longitudinal direction of the in-lamp structure on the container surface in the vicinity of the beam to disperse the stress applied to the beam supporting the in-lamp structure. In the present modification, a bead portion 2080 is formed on the bottom surface 2008 (the container surface) in the vicinity of the fifth beam 2065. The bead portion 2080 extends from the back wall 2006 to the seal groove 2003 substantially at the center of the lower side of the LDM 2050, and the lower end portion of the bead portion 2080 is connected to the bottom surface 2008 and is formed integrally with the bottom surface 2008. By forming the bead portion 2080, one undulation is formed on the bottom surface 2008 (the container surface) in the vicinity of the fifth beam 2065 in the left-right direction which is the longitudinal direction of the LDM 2050 (the in-lamp structure). Therefore, the stress transmitted from the bottom surface 2008 to the fifth beam 20065 is dispersed by the curve of the bead portion 2080, and as a result, the surface strength of the fifth beam 2065 is increased. Therefore, the rigidity of the fifth beam 2065 is improved, and the resistance to the deformation and buckling of the truss structure formed in the lamp body 2002 can be further increased. The protruding direction of the curve of the bead portion 2080 may be formed in either the direction (upward) toward the lamp chamber S or the outward direction (downward) of the lamp chamber S. The number of undulations is not limited to one, and a plurality of undulations may be formed.

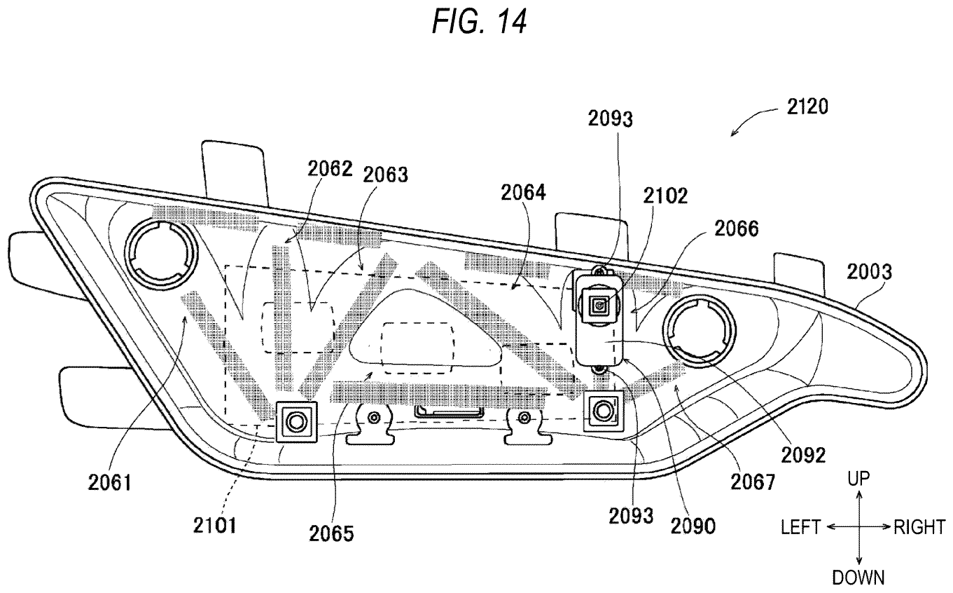

FIG. 14 shows a vehicle lamp 2120 according to two modifications, and is a front view of the lamp 2120 similarly to FIG. 7. In the truss structure formed in the lamp body 2002 according to the embodiment, since the sixth beam 2066 of the beams 2061 to 2067 is also a compressed material, it is preferable that the sixth beam 2066 also has high rigidity in order to prevent the deformation and buckling. Therefore, in the present modification, an aiming driver module 2090 is provided in the sixth beam 2066 having the third aiming member attachment hole 2043. The aiming member driven and controlled by the aiming driver module 2090 may have a known configuration in the related art, and an aiming screw 2102 (or an aiming rod) provided in the third aiming member attachment hole 2043 is connected to a lamp bracket 2101 (indicated by a broken line) that supports the lamp unit (Hi, Lo). The aiming driver module 2090 includes a driving mechanism that moves the aiming screw 2102 in the front-rear direction and a control unit thereof (not shown), and includes a metal case 2092 that accommodates the driving mechanism and the control unit. The metal case 2092 is fixed to the sixth beam 2066 by, for example, upper and lower fixing portions 2093 with the screw such that the long dimension of the case is provided in the vertical direction which is the axial direction of the sixth beam 2066. As described above, in particular, the beam serving as the compressed material of the truss structure actively supports the in-lamp structure, so that the rigidity of the truss structure of the lamp body 2002 can be further increased, and the thickness and the weight of the lamp body 2002 can be reduced accordingly. In the embodiment, the outer shape of the in-lamp structure is also described as a metal case.

Alternatively, the material of the case may be, for example, resin, and is not limited to a rectangular parallelepiped shape. Even if the outer shape of the in-lamp structure is a shape deviating from the case shape, the outer shape may be suitably deformed as long as the structure has a size and strength enough to reinforce the beam.

Although the preferred embodiment of the present disclosure has been described above, the above embodiment is an example of the present disclosure. It is possible to combine these embodiments based on the knowledge of those skilled in the art, and such forms are also included within the scope of the present disclosure. In particular, the extending direction and the form of the beams disclosed in the present specification are merely examples, and a truss structure of another form may be used as long as a triangular-based truss structure is formed. Accordingly, the arrangement of the in-lamp structure disclosed in the present specification is merely an example, and the arrangement of the in-lamp structure may be suitably changed according to the truss structure formed in the lamp body.

### Vehicle Lamp

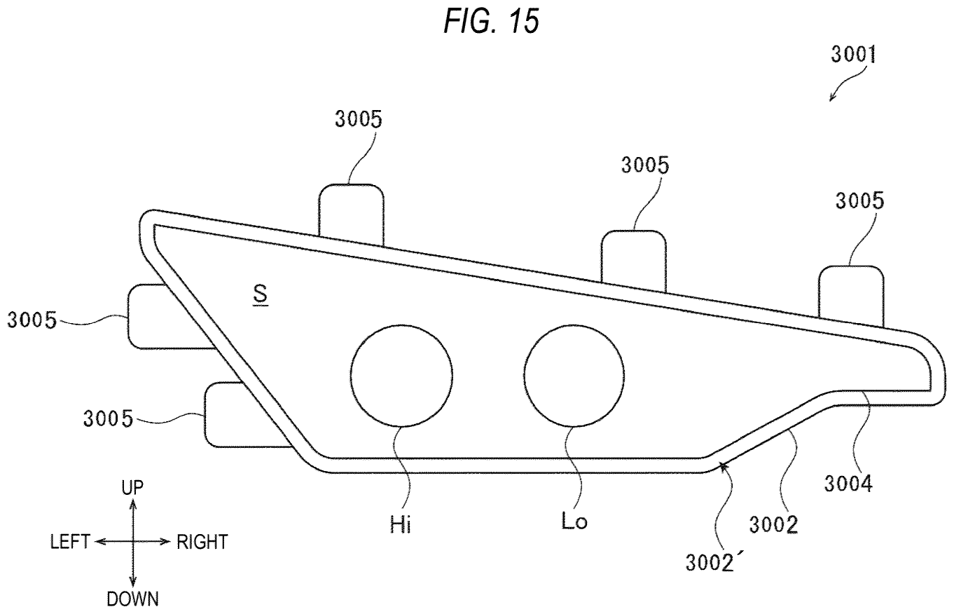

Next, the second embodiment of the present disclosure will be described with reference to FIGS. 15 to 22.

FIG. 15 is a schematic front view of a vehicle lamp 3001 according to the preferred embodiment of the present disclosure. The vehicle lamp 3001 is a headlamp that is mounted on the left and right corner portions of the front of a vehicle. As shown in FIG. 15, the vehicle lamp 3001 includes a container-shaped lamp body 3002 having a front opening 3002′, and a front cover 3004 that is attached to the front opening 3002′ of the lamp body 3002. The front cover 3004 is made of a translucent resin such as polycarbonate or glass, and the front cover 3004 is attached to the front opening 3002′ of the lamp body 3002 to define the lamp chamber S inside.

The high beam lamp unit Hi and the low beam lamp unit Lo are accommodated in the defined lamp chamber S. The high beam lamp unit Hi and the low beam lamp unit Lo are optical units that irradiate the front of the vehicle with light emitted from a light source to form a high beam light distribution or a low beam light distribution. The lamp units (Hi and Lo) may have a known configuration in the related art, such as a reflective type or a projector type lamp unit, and the type thereof does not matter.

### Overall Shape of Lamp Body

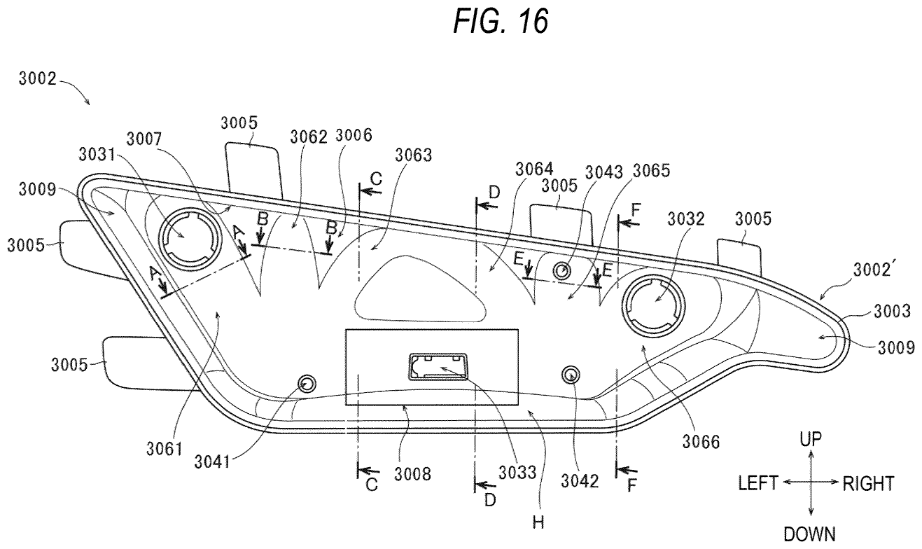

The shape of the lamp body 3002 will be described in detail. FIG. 16 is a schematic front view of the lamp body 3002.

The lamp body 3002 is molded by injection molding using a hard synthetic resin material. A seal groove 3003 for engaging with a seal leg provided on the periphery of the front cover 3004 is provided around the periphery of the front opening 3002′ of the lamp body 3002. A vehicle body attachment portion 3005 for attaching the vehicle lamp 3001 to the vehicle body is provided so as to protrude from the outer surface of the peripheral portion of the front opening 3002′ of the lamp body 3002 in a manner of corresponding to the shape of the attachment portion on the vehicle body side. The vehicle body attachment portions 3005 are provided at a total of five locations on the outer surface of the lamp body 3002, three locations on the upper side and two locations on the left side.

The lamp body 3002 includes a back wall 3006, a ceiling surface 3007, a bottom surface 3008, and left and right side surfaces 3009 as constituent surfaces. The back wall 3006 bulges rearward and is continuously connected in a curved manner to the adjacent ceiling surface 3007, bottom surface 3008, and side surfaces 3009 via the ridge lines. The ceiling surface 3007, the bottom surface 3008, and the side surfaces 3009 basically have a convex curved shape that gently bulges toward the outside of the lamp body 3002, are gently curved at the edge portions thereof, and are continuously coupled without any bent portions or steps. Therefore, the lamp body 3002 is formed in a rounded container shape as a whole.

The bottom surface 3008 extends forward from the lower edge portion of the back wall 3006, and is connected to the seal groove 3003 formed at the edge portion of the front opening 3002′ of the lamp body 3002. The side surfaces 3009 extend from the left and right edge portions of the back wall 3006 toward the lateral sides and slightly forward, and are connected to the seal groove 3003. The ceiling surface 3007 has a small extension amount, extends from the edge portion of the seal groove 3003 while gently curving rearward and downward, is connected to the back wall 3006, and is formed substantially integrally with the back wall 3006.

Therefore, the back wall 3006, the ceiling surface 3007, the bottom surface 3008, and the side surface 3009 are not mainly flat but are curved surfaces having a large curvature radius, the lamp body 3002 as a whole is formed in a container shape with the back wall 3006 as a bottom portion, and each of the back wall 3006, the ceiling surface 3007, the bottom surface 3008, and the side surface 3009 forms a container surface in which curved surfaces are smoothly continuous with each other.

A first unit attachment hole 3031, a second unit attachment hole 3032, and a third unit attachment hole 3033 are formed in the lamp body 3002. The first unit attachment hole 3031 is a hole for attaching the low beam lamp unit Lo, and is formed in the upper left side of the back wall 3006. The second unit attachment hole 3032 is a hole for attaching a back cover (not shown), and is formed on the upper right side of the back wall 3006. The third unit attachment hole 3033 is a hole for attaching a light driver module (not shown) that controls lighting of the lamp units (Hi, Lo), and is formed substantially at the center of the lower portion of the back wall 3006.

In the lamp body 3002, a first aiming member attachment hole 3041, a second aiming member attachment hole 3042, and a third aiming member attachment hole 3043 are formed around the third unit attachment hole 3033. An aiming member (not shown) having a known configuration in the related art is attached to the aiming member attachment holes 3041, 3042, and 3043.

The first aiming member attachment hole 3041 is formed in the lower edge portion of the back wall 3006 so as to be formed between the first unit attachment hole 3031 and the third unit attachment hole 3033. The second aiming member attachment hole 3042 is formed in the right lower edge portion of the back wall 3006 so as to be offset from the first aiming member attachment hole 3041 in the opposite direction by approximately the same distance as the distance from the third unit attachment hole 3033 to the first aiming member attachment hole 3041. The third aiming member attachment hole 3043 is formed in the right upper end portion of the back wall 3006 so as to be formed substantially vertically above the second aiming member attachment hole 3042.

### Back Wall and Beam

A first beam 3061, a second beam 3062, a third beam 3063, a fourth beam 3064, a fifth beam 3065, and a sixth beam 3066 constituting a part of the back wall 3006 extend from the upper end portion of the back wall 3006 to the lower end portion of the back wall 3006.

Here, a part of the back wall 3006 other than the part constituted by the beams 3061 to 3066 is referred to as a back wall main body 3069.

The first beam 3061 extends so as to connect the first aiming member attachment hole 3041 on the lower left side of the back wall 3006 and the first unit attachment hole 3031 on the upper side as end points. Therefore, the first beam 3061 is inclined to the left in the front view.

The second beam 3062 extends straight from the first aiming member attachment hole 3041 on the lower left side of the back wall 3006 to the upper end portion of the back wall 3006 generally upward in the front view.

The third beam 3063 extends from the first aiming member attachment hole 3041 on the lower left side of the back wall 3006 to the upper end portion of the back wall 3006 toward the upper right. Therefore, the third beam 3063 is inclined to the right in the front view.

The fourth beam 3064 extends from the second aiming member attachment hole 3042 on the lower right side of the back wall 3006 to the upper end portion of the back wall 3006 toward the upper left. Therefore, the fourth beam 3064 is inclined to the left in the front view.

The fifth beam 3065 extends so as to connect the second aiming member attachment hole 3042 on the lower right side of the back wall 3006 and the third aiming member attachment hole 3043 on the upper side as end points. Therefore, the fifth beam 3065 extends straight to the upper end portion of the back wall 3006 generally upward in the front view.

The sixth beam 3066 extends so as to connect the second aiming member attachment hole 3042 on the lower right side of the back wall 3006 and the second unit attachment hole 3032 on the upper side as end points. Therefore, the sixth beam 3066 is inclined to the right in the front view.

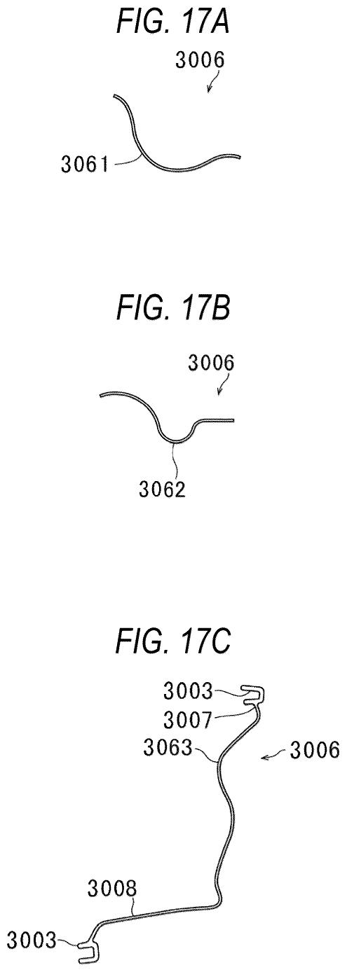

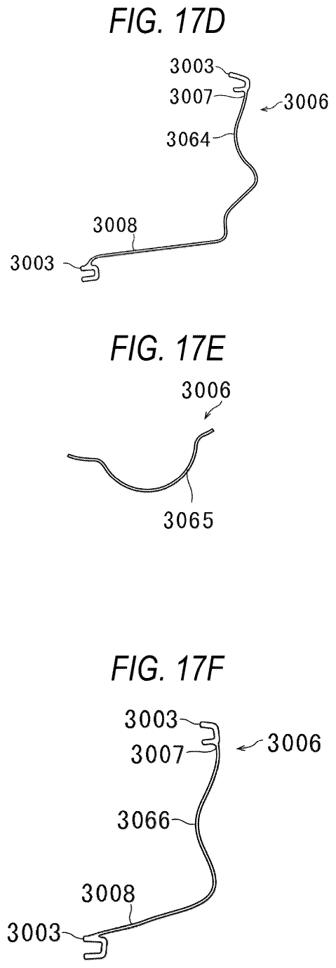

FIGS. 17A to 17F are end views of the beams 3061 to 3066 along the cutting line shown in FIG. 16. FIG. 17A is an end C view taken along a line A-A in FIG. 16, and mainly shows the cross-sectional shape of the first beam 3061. FIG. 17B is an end view taken along a line B-B in FIG. 16, and mainly shows the cross-sectional shape of the second beam 3062.

FIG. 17C is an end view taken along a line C-C in FIG. 16, and mainly shows the cross-sectional shape of the third beam 3063. FIG. 17D is an end view taken along a line D-D in FIG. 16, and mainly shows the cross-sectional shape of the fourth beam 3064. FIG. 17E is an end view taken along a line E-E in FIG. 16, and mainly shows the cross-sectional shape of the fifth beam 3065. FIG. 17F is an end view taken along a line F-F in FIG. 16, and mainly shows the cross-sectional shape of the sixth beam 3066.

As shown in FIGS. 17A to 17F, the cross-sectional shapes of the beams 3061 to 3066 perpendicular to the extending direction thereof are all a substantially arc shape, although differ in radius of curvature, width, and amount of protrusion. The protruding direction of the curved surface of each of the beams 3061 to 3066 may be formed in either the direction (forward) toward the lamp chamber S or the outward direction (rearward) of the lamp chamber S, and in the present embodiment, the beams 3061 to 3066 are formed as beams curved toward the direction (forward) toward the lamp chamber S. The beams 3061 to 3066 are smoothly connected to the back wall main body 3069 via the ridge lines. The cross-sectional shape of the lamp body 3002 is constructed continuously without any bent portions while maintaining a constant wall thickness.

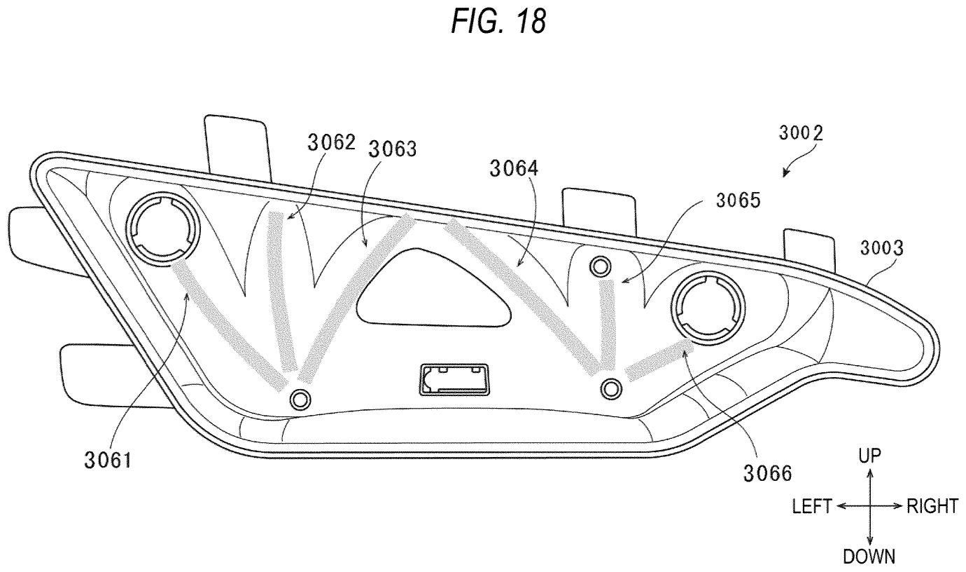

FIG. 18 is a front view of the lamp body 3002, and shows the beams 3061 to 3066 in light black. As shown in FIG. 18, the beams 3061 to 3066 have a truss structure in triangular units. In the truss structure, the beams 3061 to 3066 extend from the upper end portion to the lower end portion of the back wall 3006, and one beam extends obliquely from the end portion of another beam. Here, the thick seal groove 3003 is incorporated in the truss structure. Therefore, the lamp body 3002 including the back wall 3006 has a structure that is less likely to deform under a load. Since the beams 3061 to 3066 themselves have curved surfaces having a substantially arc-shaped cross section to disperse stress, the beams 3061 to 3066 have a highly rigid structure that is more resistant to deformation.

Therefore, the lamp body 3002 according to the present embodiment has a structure having higher rigidity than a lamp body that does not have such a truss structure. By improving the rigidity of the lamp body 3002, the lamp body 3002 can be thinner than that in the related art.

### Petaloid Structure

The present invention is not limited to the above configuration, and the bending rigidity can be increased by forming at least a part of the constituent surface of the lamp body 3002 with a curved surface. By increasing the rigidity of the lamp body 3002, it is not necessary to provide a reinforcing rib, and weight reduction can be achieved. As an example, a structure around the third unit attachment hole 3033 which is an opening of the lamp body 3002 will be described.

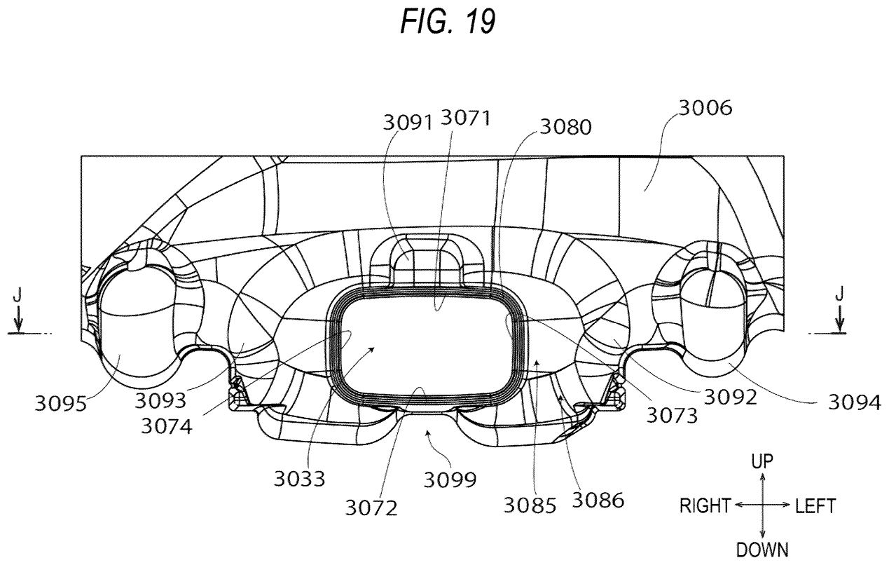

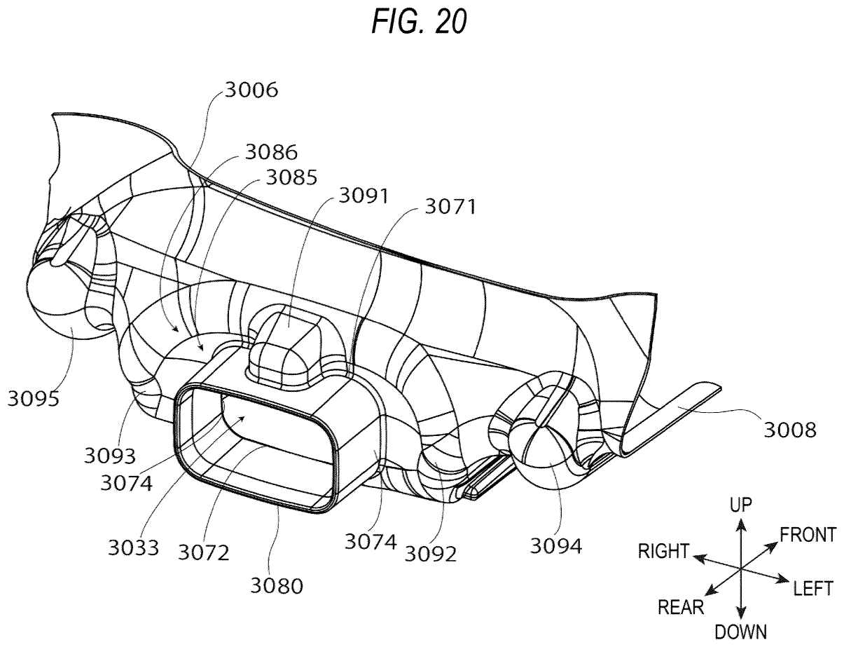

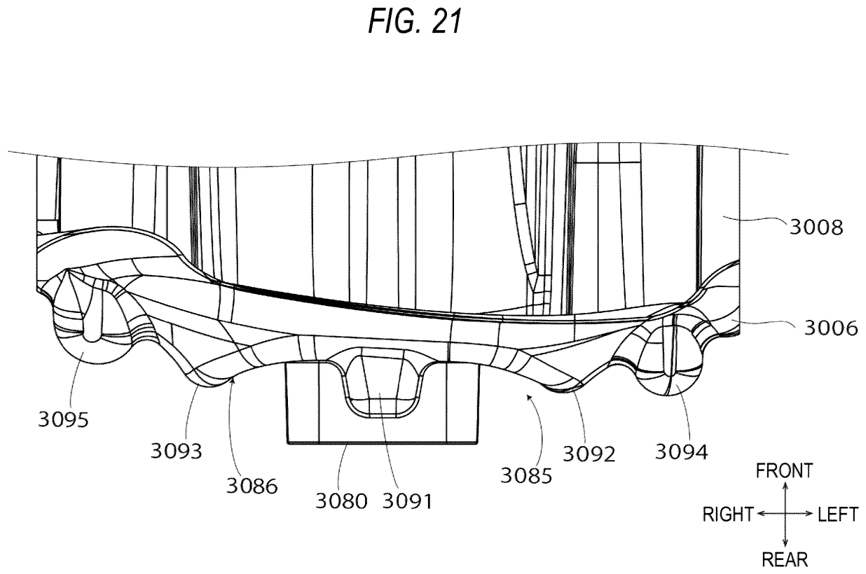

FIGS. 19 to 21 show the portion H of the lamp body 3002 shown in FIG. 16. FIG. 19 is a back surface C view of the portion H. FIG. 20 is a rear perspective view of the portion H. FIG. 21 is a plan C view of the portion H.

The third unit attachment hole 3033 is formed substantially at the center of the lower portion of the back wall 3006 of the lamp body 3002, and is formed in a rectangular shape having an upper side 3071, a lower side 3072, a left side 3073, and a right side 3074.

Since the sides 3071 to 3074 are curves in which the central portions bulge to the outside and the connection portion (the corner portion) between the sides 3071 to 3074 is also formed in an arc shape, the third unit attachment hole 3033 has a rounded shape as a whole.

In order to fit and stably support a lamp driver module (not shown), a cylindrical fitting portion 3080 is provided at the peripheral portion of the third unit attachment hole 3033 so as to extend the third unit attachment hole 3033. The fitting portion 3080 protrudes rearward from the outer surface of the back wall 3006, and the shape of the inner hole is the shape of the third unit attachment hole 3033. The lamp driver module is attached to the third unit attachment hole 3033 by inserting and fitting a fitted portion (not shown) of the lamp driver module into the fitting portion 3080.

As described above, the lamp body 3002 is mainly implemented by a curved surface as a whole, and is basically implemented by a curved surface having a large curvature radius and largely bulging to the outside also in the region (the portion H) around the third unit attachment hole 3033 substantially at the center of the lower portion of the back wall 3006 having the third unit attachment hole 3033. Further, by forming a recess or a protrusion in this region, the rigidity of the lamp body 3002 in this region is further improved.

In the back wall 3006, a plurality of recesses or protrusions are formed in the region around the third unit attachment hole 3033 so as to surround the third unit attachment hole 3033.

Specifically, a first protrusion 3091 that has a hump shape and that protrudes rearward is formed above the upper side 3071. A second protrusion 3092 protruding rearward is formed in the left vicinity of the left side 3073. Similarly, a third protrusion 3093 protruding rearward is formed in the right vicinity of the right side 3074. The back wall 3006 has a substantially constant wall thickness, and each of the protrusions 3091 to 3093 has a substantially convex hemispherical shape that is hollow and that protrudes rearward.

The protrusions 3091 to 3093 are formed in an annular shape around the third unit attachment hole 3033 so as to surround the third unit attachment hole 3033, and the region around the third unit attachment hole 3033 of the lamp body 3002 has a substantially petaloid shape with the protrusions 3091 to 3093 as a petal.

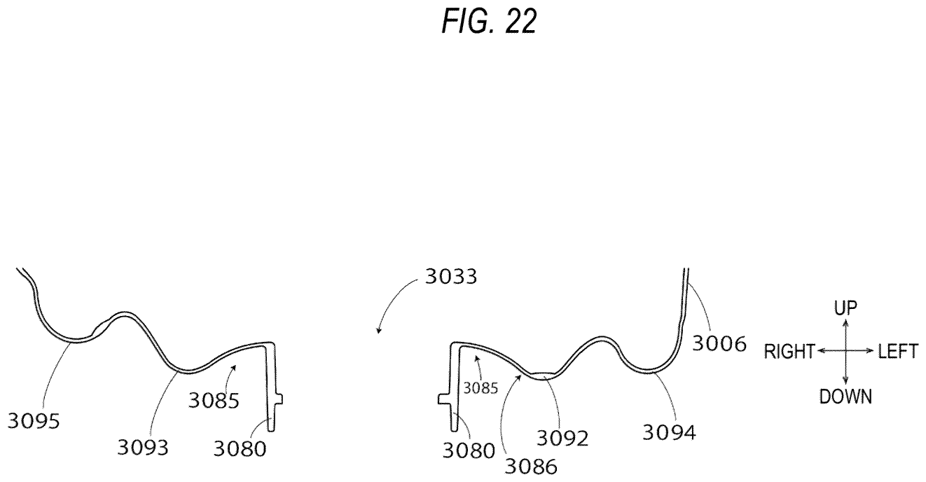

FIG. 22 is a horizontal end view taken along a line J-J shown in FIG. 19. The line J-J passes through the third protrusion 3093, the third unit attachment hole 3033, and the second protrusion 3092.

As shown in FIG. 22, the protrusions 3091 to 3093 are formed of curved surfaces, and the boundary portion thereof is also smoothly connected via a ridge line and is continuously formed on the back wall 3006 without a bent portion.

By the third protrusion 3093, the third unit attachment hole 3033, and the second protrusion 3092, the horizontal cross-sectional shape of the back wall 3006 passing through the third unit attachment hole 3033 is formed in a wavy shape in which unevenness is continuous.

In this way, by providing a portion having a cross-sectional shape in which the unevenness is continuous in at least a partial region of the lamp body 3002, the cross section second moment can be improved, and a structure resistant to the bending stress can be obtained. Accordingly, the rigidity of the lamp body 3002 is improved. With this configuration, the peripheral region of the third unit attachment hole 3033 of the lamp body 3002 can have the same degree of rigidity as in the related art even when the thickness is reduced without providing a reinforcing rib.

The number of protrusions constituting petaloid-shaped petals is not specified, and may be further increased from the present configuration. In the present embodiment, the petaloid petal shape is a convex shape, and may be a concave shape or a mixture of a convex shape and a concave shape. Since the petaloid structure is provided on the back wall 3006, the protrusion is a recess and the recess is a protrusion in the back surface view, and thus the petal shape is a curved surface provided on the back wall 3006 regardless of whether the petal shape is a recess or a protrusion, and the cross section second moment of the back wall 3006 is improved.

Since the third unit attachment hole 3033 is an opening, that is, a through hole, the third unit attachment hole 3033 is a notch in the lamp body 3002 and has lower rigidity than other portions. Since the third unit attachment hole 3033 is an attachment hole into which a lamp component is inserted and fitted, higher rigidity is required. Therefore, by forming the petaloid shape around the third unit attachment hole 3033, the rigidity of the opening peripheral region having low rigidity in the back wall 3006 is increased. In this way, when the opening and the attachment hole for the lamp component are formed at the center of the petaloid shape, the rigidity of the lamp body 3002 can be preferably improved around the hole having low rigidity. In the present embodiment, the third unit attachment hole is an attachment hole for the lamp driver module, and the third unit attachment hole is a connector hole for the lamp driver module. However, the present invention is not limited thereto, and the opening also includes an attachment hole or a fitting hole for a component such as a socket bulb, a back cover, or an actuator, an insertion hole for a cable or a ground, a work hole for attaching and detaching a component, a window through which air or moisture passes, and the like.

The shape of the opening at the center of the petaloid shape is not limited to a substantially rectangular shape, and may be a circular shape or a polygonal shape.

The center of the petaloid shape is not limited to the opening, and may be a protrusion or a recess, or may be a portion where nothing is formed. Due to the formation of the unevenness of petaloid shape petals, the cross section second moment of the region where the petaloid shape is provided increases, and the rigidity of the lamp body 3002 is improved. The region where the petaloid shape is formed is not limited to the back wall 3006, and may be formed on the bottom surface 3008, the ceiling surface 3007, or the left and right side surfaces 3009.

The protrusions or the recesses constituting the petaloid-shaped petals are preferably provided uniformly in the circumferential direction with respect to the hole or the uneven portion serving as the center of the petaloid shape. The protrusions or the recesses more preferably face each other as a pair, which provides a good balance in distributing the load.

As shown in FIG. 19, a first recess 3099 is formed below the lower side 3072 of the third unit attachment hole 3033. A part of the first recess 3099 is formed in the bottom surface 3008, and a recess toward the lower side 3072 extends also in the front-rear direction, also recesses the bottom surface 3008, and is a groove-shaped recess that is recessed in the upper-lower direction and that extends in the front-rear direction. The first recess 3099 constitutes one of the petaloid shaped petals around the third unit attachment hole 3033.

By the first recess 3099, complicated and three-dimensional unevenness is formed in the peripheral region around the third unit attachment hole 3033 of the back wall 3006.

Each of the protrusions 3091 to 3093 and the recess 3099 is smoothly continuous, has a substantially constant thickness, is connected without a bent portion, and has a wavy cross-sectional shape.

In the present embodiment, as shown in FIGS. 19 to 22, the back wall 3006 in the peripheral region of the third unit attachment hole 3033 is recessed toward the third unit attachment hole 3033, and an annular recess 3085 is formed around the third unit attachment hole 3033 and the fitting portion 3080 with the third unit attachment hole 3033 as a bottom portion. In other words, the back wall 3006 in the peripheral region of the third unit attachment hole 3033 gently protrudes forward around the third unit attachment hole 3033, and the third unit attachment hole 3033 is formed in the protruding center portion.

On the relatively outer side of the annular recess 3085 in the radial direction, an annular protrusion 3086 bulging in a doughnut shape so as to surround the annular recess 3085 and protruding rearward in an annular shape around the third unit attachment hole 3033 is formed.

The first protrusion 3091, the second protrusion 3092, the third protrusion 3093, and the first recess 3099 described above are formed on the annular protrusion 3086, and these protrusions and recess are protrusions one step higher and a recess one step lower than the annular protrusion 3086. A relative recess is formed between the protrusions 3091 to 3093 formed apart from each other, and an annular uneven portion in which unevenness is repeated around the third unit attachment hole 3033 is formed around the third unit attachment hole 3033. In the present embodiment, since the third unit attachment hole 3033 is formed in the lower portion of the back wall 3006 and the first recess 3099 is formed in the bottom surface 3008, a part of the annular uneven portion is also provided over the bottom surface 3008.

By the protrusion and the recess, complicated and three-dimensional unevenness is formed in the peripheral region around the third unit attachment hole 3033 of the back wall 3006. Each of the protrusions 3091 to 3093 and the recess 3099 is smoothly continuous via a ridge line, has a substantially constant wall thickness, is connected without a bent portion, and has a wavy cross-sectional shape. In the region of the back wall 3006 around the third unit attachment hole 3033, the cross section second moment increases in two directions of the front-rear direction and the upper-lower direction, and the rigidity of the lamp body 3002 in the region around the third unit attachment hole 3033 is increased.

Although the unevenness shape is complicated due to the annular protrusion 3086 and the annular recess 3085, there is no problem even if the annular protrusion 3086 and the annular recess 3085 are not formed and only the protrusions 3091 to 3093 are formed around the third unit attachment hole 3033.

As shown in FIGS. 19 to 21, a fourth protrusion 3094 is formed further leftward of the second protrusion 3092 provided leftward of the left side 3073. The fourth protrusion 3094 is formed apart from the second protrusion 3092, and a relative recess is formed between the second protrusion 3092 and the fourth protrusion 3094.

Similarly, a fifth protrusion 3095 is formed further rightward of the third protrusion 3093 provided rightward of the right side 3074. The fifth protrusion 3095 is formed apart from the third protrusion 3093, and a relative recess is formed between the third protrusion 3093 and the fifth protrusion 3095.

The fourth protrusion 3094 and the fifth protrusion 3095 have the same configuration as the protrusions 3091 to 3093, and have a hollow convex hemispherical shape formed in a hump shape toward the rear.

The fifth protrusion 3095, the third protrusion 3093, the second protrusion 3092, and the fourth protrusion 3094 are formed continuously in the horizontal direction. Each of the protrusions is formed without a step or a bent portion, and as shown in FIG. 22, the horizontal cross-sectional view around the third unit attachment hole 3033 is formed in a further continuous wavy shape by these protrusions 3091, 3092, 3094, and 3095. In this way, it is preferable to form, in the protrusion or recess (a first petal) constituting the petaloid-shaped petals, another protrusion or recess (a second petal) on the outer side in the radial direction when viewed from the center of the petaloid shape because the number of curved surfaces increases in the peripheral region of the third unit attachment hole 3033 and the rigidity of the lamp body 3002 is further improved. It is more preferable that a plurality of protrusions or recesses are linearly arranged from the third unit attachment hole 3033 in a certain radial direction, such as the fifth protrusion 3095 and the third protrusion 3093, and the second protrusion 3092 and the fourth protrusion 3094.

The present invention is not limited thereto, and still another protrusion or recess may be formed, for example, between the first protrusion 3091 and the second protrusion 3092 in the circumferential direction, and at a position that is further away from the third unit attachment hole 3033 than are the first protrusion 3091 and the second protrusion 3092 in the radial direction.

Although the preferred embodiment of the present disclosure has been described above, the above embodiment is an example of the present disclosure. It is possible to combine these embodiments based on the knowledge of those skilled in the art, and such forms are also included within the scope of the present disclosure.

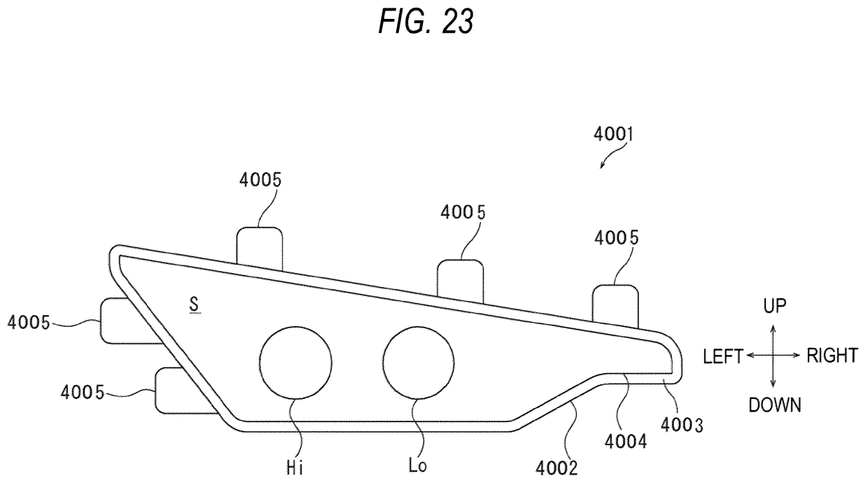

Next, the second embodiment of the present disclosure will be described with reference to FIGS. 23 to 29C.

FIG. 23 is a front view of a vehicle lamp 4001 according to a preferred embodiment of the present disclosure. The vehicle lamp 4001 in FIG. 23 includes a lamp body 4002, a front lens 4004, and a plurality of brackets 4005 for attaching the lamp body 4002 to the vehicle body. The lamp body 4002 is made of resin or the like, has a container shape in a vertical cross section along the front-rear direction, with a back wall extending in the upper-lower direction and a bottom wall extending in the front-rear direction, and has an opening at the front end thereof. As indicated by a reference sign 4003 in the drawings, a groove-shaped seal portion 4003 recessed rearward is provided on the entire circumference of the front opening of the lamp body 4002. The front lens 4004 is made of a light-transmitting material such as resin or glass, is fixed to the seal portion 4003, and defines the lamp chamber S sealed inside the lamp body 4002.

The high beam lamp unit Hi and the low beam lamp unit Lo are accommodated in the defined lamp chamber S shown in FIG. 23, both of which emit headlight forward (toward the viewer on the page). The high beam lamp unit Hi and the low beam lamp unit Lo are optical units that irradiate the front of the vehicle with light emitted from a light source to form a high beam light distribution or a low beam light distribution. The lamp units (Hi and Lo) have a known configuration in the related art, such as a reflective type or a projector type lamp unit, and the type thereof does not matter.

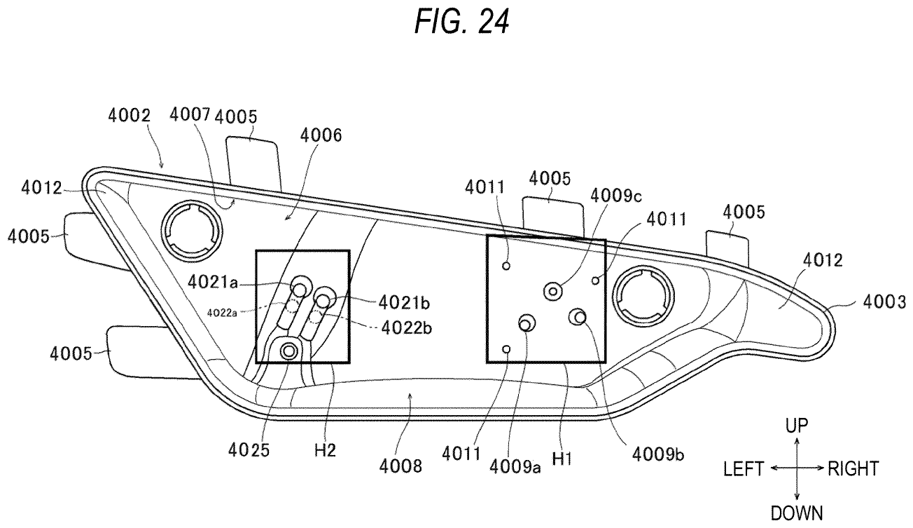

Next, the shape of the lamp body 4002 will be described in detail. FIG. 24 is a schematic front view of the lamp body 4002. The lamp body 4002 is molded by injection molding using a hard synthetic resin material. The lamp body 4002 includes a back wall 4006, a ceiling surface 4007, a bottom surface 4008, and left and right side surfaces 4009 as constituent surfaces. The back wall 4006 bulges rearward and is continuously connected in a curved manner to the adjacent ceiling surface 4007, bottom surface 4008, and side surfaces 4009 via the ridge lines. The ceiling surface 4007, the bottom surface 4008, and the side surfaces 4009 basically have a convex curved shape that gently bulges toward the outside of the lamp body 4002, are gently curved at the edge portions thereof, and are continuously coupled without any bent portions or steps. Therefore, the lamp body 4002 is formed in a rounded container shape as a whole.

The bottom surface 4008 shown in FIG. 24 extends forward from the lower edge portion of the back wall 4006, and is connected to the seal portion 4003 provided at the edge portion of the front opening of the lamp body 4002. The side surfaces 4009 extend from the left and right edge portions of the back wall 4006 toward the lateral sides and slightly forward, and are connected to the seal portion 4003. The ceiling surface 4007 has a small extension amount, extends from the edge portion of the seal portion 4003 while gently curving rearward and downward, is connected to the back wall 4006, and is formed substantially integrally with the back wall 4006. Therefore, the back wall 4006, the ceiling surface 4007, the bottom surface 4008, and the side surface 4012 are not mainly flat but are curved surfaces having a large curvature radius, the lamp body 4002 as a whole is formed in a container shape with the back wall 4006 as a bottom portion, and each of the back wall 4006, the ceiling surface 4007, the bottom surface 4008, and the side surface 4012 forms a container surface in which curved surfaces are smoothly continuous with each other.

As shown in a region indicated by a reference sign H1 in FIG. 24, the back wall 4006 of the lamp body 4002 is provided with three protruding portions 4009a to 4009c to which an aiming actuator 4010 is attached, and three fixing portions 4011 of an aiming bracket (not shown). The aiming actuator 4010 is a lamp component constituting an aiming mechanism for adjusting the orientation of the lamp units (Hi, Lo) in FIG. 23.

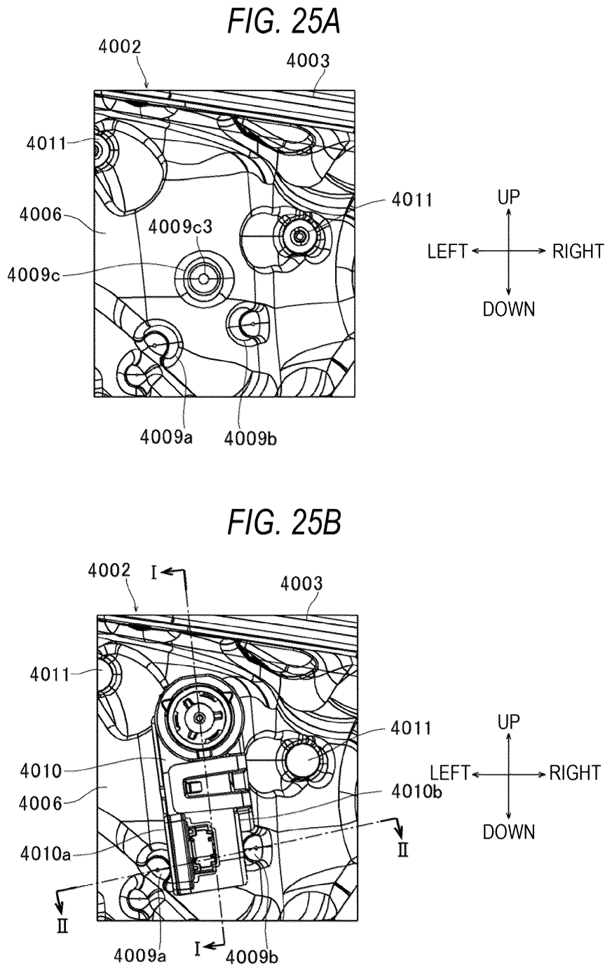

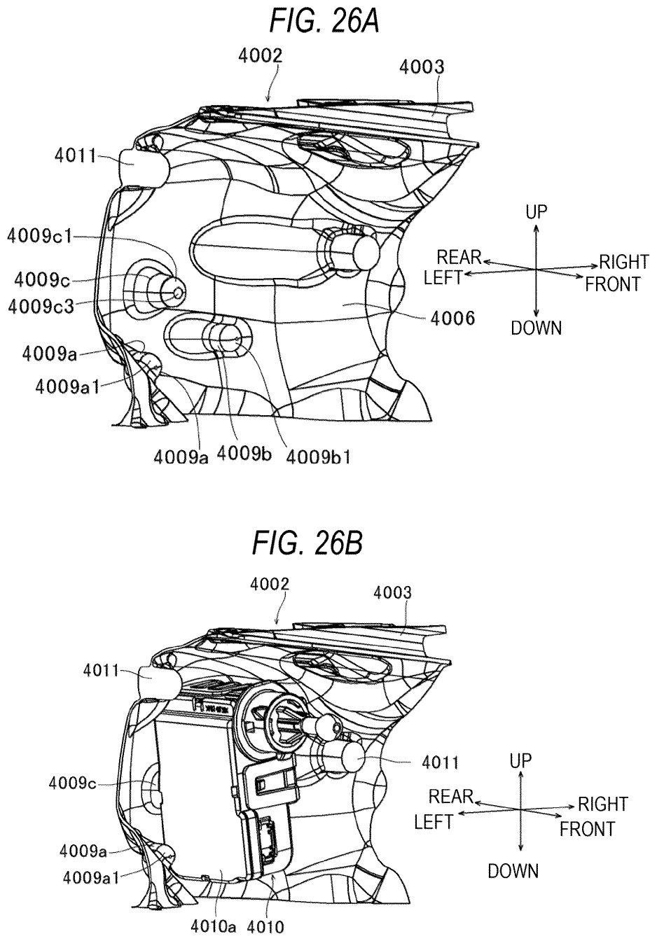

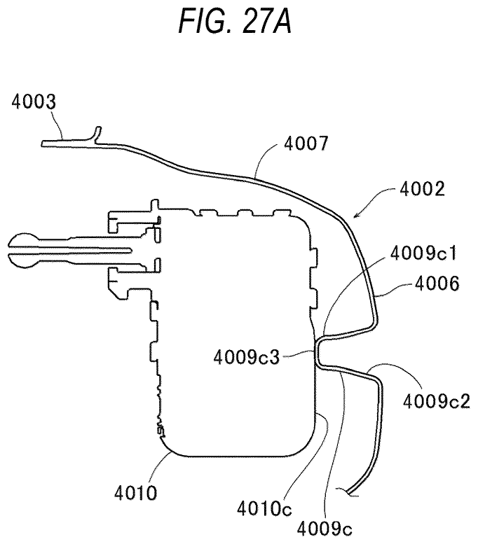

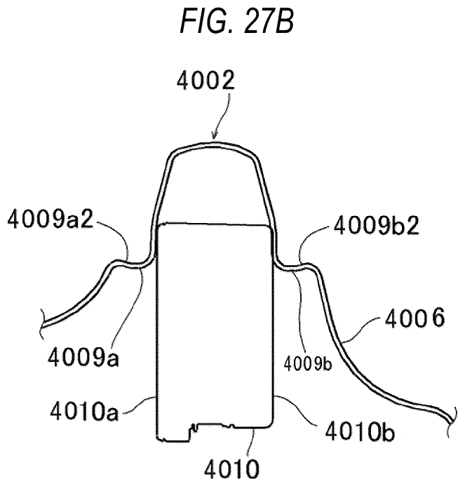

The three protruding portions 4009a to 4009c of the lamp body 4002 will be described with reference to FIGS. 25A, 25B, 26A, and 26B. The three protruding portions include the first protruding portion 4009a, the second protruding portion 4009b, and the third protruding portion 4009c. As shown in FIGS. 27A and 27B, the protruding portions 4009a, 4009b, and 4009c have a bottomed tubular shape in which base end portions 4009a2, 4009b2, and 4009c2 are open toward the outside of the lamp chamber S in FIG. 23, that is, toward the rear of the lamp body 4002, and distal end portions 4009a1, 4009b1, and 4009c1 are closed and protrude toward the inside of the lamp chamber S. Each of the distal end portions 4009a1, 4009b1, 4009cl is formed in a hemispherical shape, and a flat portion 4009c3 is provided at the top of the distal end portion 4009c3 of the third protruding portion 4009c.

As shown in FIGS. 25B, 26B, and 27B, the aiming actuator 4010 is positioned to the left and right in a state in which a left side surface 4010a and a right side surface 4010b are respectively sandwiched by the first protruding portion 4009a and the second protruding portion 4009b. As shown in FIG. 27A, the aiming actuator 4010 is positioned rearward in a state in which a rear surface 4010c is in contact with the flat portion 4009c3 of the distal end portion 4009cl of the third protruding portion 4009c. The aiming actuator 4010 is held from the front by an actuator bracket (not shown) fixed to the three fixing portions 4011 by screwing or the like.

The aiming actuator 4010 shown in FIGS. 25B, 26B, 27A, and 27B is fixed to the lamp body 4002 in a state in which the left and right of the aiming actuator 4010 are sandwiched by the first protruding portion 4009a and the second protruding portion 4009b and in which the front and rear of the aiming actuator 4010 are sandwiched by the actuator bracket (not shown) and the third protruding portion 4009c.

First, the plurality of bottomed tubular protruding portions 4009a to 4009c integrally formed with the lamp body 4002 so as to protrude to the inside of the lamp chamber S shown in FIG. 23 protrude from a part of the back wall 4006 of the lamp body 4002 so as to have a hollow shape, so that the weight is not increased and the rigidity of the lamp body 4002 against the bending stress is improved. The plurality of protruding portions 4009a to 4009c come into contact with the outer periphery of the aiming actuator 4010 which is a lamp component, thereby restricting the movement in the contact direction and positioning the aiming actuator 4010 to the lamp body 4002. According to the plurality of protruding portions 4009a to 4009c, since necessary and sufficient rigidity is ensured in the lamp body 4002 without providing a rib, weight reduction of the lamp body 4002 and the vehicle lamp 4001 can be achieved. The protruding portions 4009a to 4009c are in contact with the aiming actuator 4010 which is a lamp component, so that positioning with respect to the lamp body 4002 can be performed with a simple structure.

The aiming actuator 4010 shown in FIGS. 25B and 26B is inserted between the first protruding portion 4009a and the second protruding portion 4009b while being in contact with the distal end portions 4009a1 and 4009b1 having a hemispherical shape, so that the aiming actuator 4010 is guided to be provided at a predetermined position in the left-right direction along the hemispherical surface. In the present embodiment, the left and right side surfaces 4010a and 4010b of the aiming actuator 4010, which is a lamp component, are held from the left and right two directions by the pair of first protruding portion 4009a and second protruding portion 4009b, but the lamp component is not limited to being held from the two directions, and may be held from three or more directions by three or more protruding portions in contact with the outer side surface.

As shown in FIGS. 26B and 27B, the aiming actuator 4010 is held by the third protruding portion 4009c via the rear surface 4010c, so that the lamp component is held in a state of being separated from the back wall 4006 of the lamp body 4002. As a result, the aiming actuator 4010 is positioned and held in a certain direction without being inclined based on the shape of the back wall 4006 even if the back wall 4006 is inclined at an angle, formed in a wavy shape, or formed in any other shape. The aiming actuator 4010 is held by the distal end portion 4009c1 of the third protruding portion 4009c in a state of being in contact with the flat portion 4009c3 having a surface along the upper-lower direction, so that the aiming actuator 4010 is held in a stable state of being less likely to be inclined in the upper-lower direction and the left-right direction than when the aiming actuator 4010 is held by the hemispherical surface.

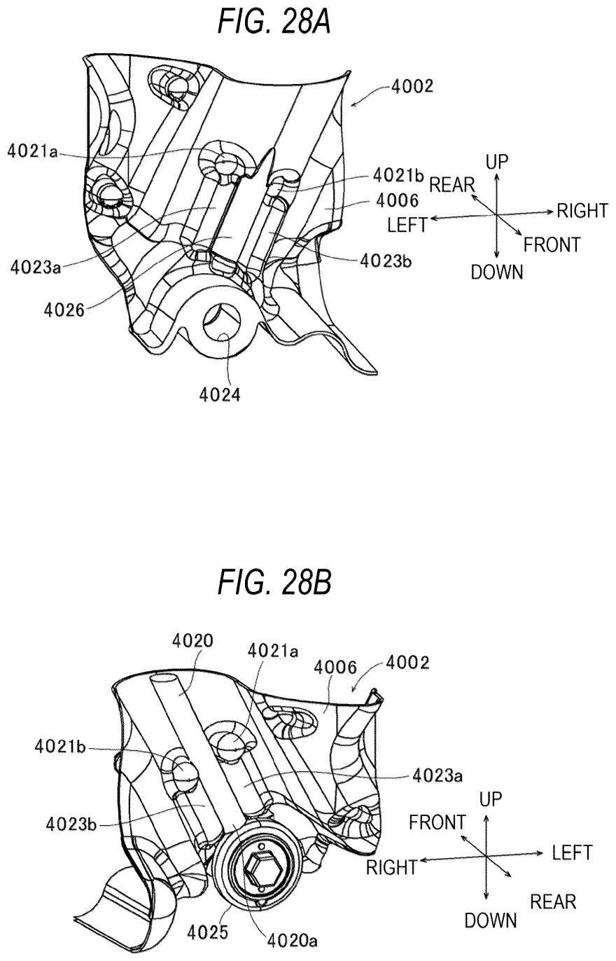

As shown in FIGS. 24, 28A, and 28B, in a region indicated by a reference sign H2, an attachment hole 4024 for an adjusting screw 4025 that adjusts the orientation of the lamp units (Hi, Lo) in FIG. 23 based on the rotation position is formed in the back wall 4006 of the lamp body 4002. A pair of left fourth protruding portion 4021a and right fifth protruding portion 4021b are provided above the attachment hole 4024, and a sixth protruding portion 4023a and a seventh protruding portion 4023b that extend toward the attachment hole 4024 are provided on the fourth protruding portion 4021a and the fifth protruding portion 4021b, respectively.

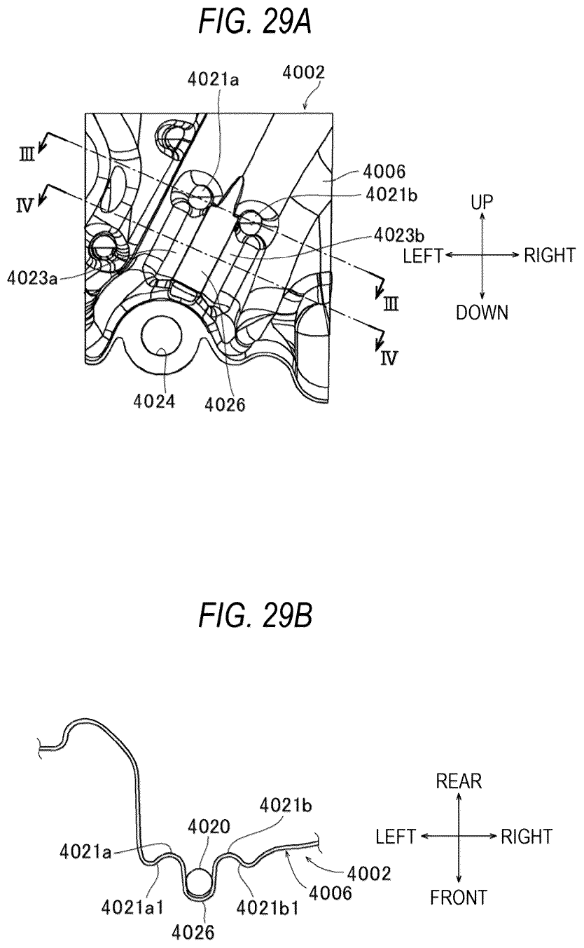

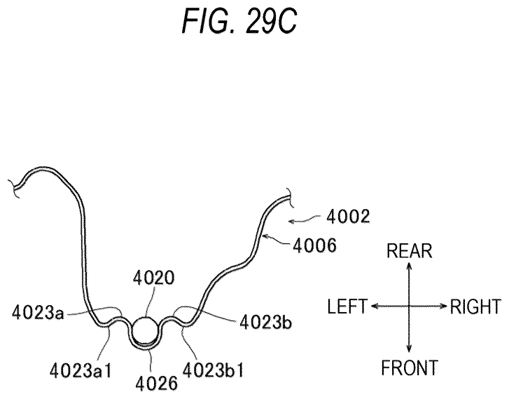

As shown in FIGS. 28A, 28B, and 29B, the fourth protruding portion 4021a and the fifth protruding portion 4021b have a bottomed tubular shape in which base end portions 4021al and 4021b1 are open toward the inside of the lamp chamber S in FIG. 23, that is, toward the front of the lamp body 4002, and the distal end portions are closed and protrude toward the outside of the lamp chamber S. Similarly, as shown in FIGS. 28A, 28B, and 29C, the sixth protruding portion 4023a and the seventh protruding portion 4023b have a bottomed tubular shape in which base end portions 4023a1 and 4023b1 are open toward the inside of the lamp chamber S in FIG. 23, that is, toward the front of the lamp body 4002, and the distal end portions are closed and protrude toward the outside of the lamp chamber S. The sixth protruding portion 4023a and the seventh protruding portion 4023b are formed continuously with the fourth protruding portion 4021a and the fifth protruding portion 4021b, respectively, and are formed in a longitudinal shape so as to be parallel to each other toward the attachment hole 4024. The fourth protruding portion 4021a and the fifth protruding portion 4021b protrude higher than the sixth protruding portion 4023a and the seventh protruding portion 4023.

The adjusting screw 4025 shown in FIG. 28B is rotated by an adjusting driver 4020 which is a lamp component inserted from above. As shown in FIGS. 28A, 28B, and 29B, the fourth protruding portion 4021a and the fifth protruding portion 4021b are formed on the lamp body 4002 so as to have substantially the same interval as the diameter of the adjusting driver 4020, and as shown in FIGS. 28A, 28B, and 29C, the sixth protruding portion 4023a and the seventh protruding portion 4023b are also formed on the lamp body 4002 so as to have substantially the same interval as the diameter of the adjusting driver 4020.

As shown in FIG. 28B, the adjusting driver 4020 is inserted between the fourth protruding portion 4021a and the fifth protruding portion 4021b that are provided at substantially the same interval as the diameter of the adjusting driver 4020, thereby being positioned to the left and right with respect to the adjusting screw 4025. The adjusting driver 4020 is inserted between the sixth protruding portion 4023a and the seventh protruding portion 4023b that extend from the fourth protruding portion 4021a and the fifth protruding portion 4021b to the vicinity of the attachment hole 4024 of the adjusting screw 4025, so that the distal end portion 4020a is accurately guided to the engaging portion of the adjusting driver 4020 in the adjusting screw 4025.

As shown in FIGS. 28B and 29B, the distal end portions of the fourth protruding portion 4021a and the fifth protruding portion 4021b are both formed in a hemispherical shape, and as shown in FIGS. 28B and 29C, the sixth protruding portion 4023a and the seventh protruding portion 4023b are formed such that the vertical cross section with respect to the longitudinal direction has a semi-cylindrical shape. The adjusting driver 4020 is inserted into a semi-cylindrical recess 4026 conforming to the adjusting driver 4020, which is formed between the fourth protruding portion 4021a and the fifth protruding portion 4021b having a hemispherical shape and the sixth protruding portion 4023a and the seventh protruding portion 4023 having a semi-cylindrical shape by coming into contact with the distal end portions of the fourth protruding portion 4021a and the fifth protruding portion 4021b and the sixth protruding portion 4023a and the seventh protruding portion 4023, thereby being guided to be provided in the recess 4026 along the hemispherical surface and the semi-cylindrical outer periphery surface.

The plurality of bottomed tubular protruding portions 4021a, 4021b, 4023a, and 4023b integrally formed with the lamp body 4002 so as to protrude to the outside of the lamp chamber S shown in FIG. 23 each protrude from a part of the back wall 4006 of the lamp body 4002 so as to have a hollow shape, so that the weight is not increased and the rigidity of the lamp body 4002 against the bending stress is improved. The fourth protruding portion 4021a and the fifth protruding portion 4021b are in contact with the adjusting driver 4020, which is a lamp component, from both sides, thereby positioning the adjusting driver 4020 with respect to the adjusting screw 4025. The fourth protruding portion 4021a and the fifth protruding portion 4021b are formed higher than the sixth protruding portion 4023a and the seventh protruding portion 4023b, so that the distal end of the adjusting driver 4020 can be easily inserted. The sixth protruding portion 4023a and the seventh protruding portion 4023b have a longitudinal shape toward the adjusting screw 4025, so that the adjusting driver 4020 is easily guided to the adjusting screw 4025.

According to the plurality of protruding portions 4021a, 4021b, 4023a, and 4023b, since necessary and sufficient rigidity is ensured in the lamp body 4002 without providing a rib, weight reduction of the lamp body 4002 and the vehicle lamp 4001 can be achieved. By the protruding portions 4021a, 4021b, 4023a, and 4023b, the guide portion of the adjusting driver 4020 for the adjusting screw 4025 can be formed in the lamp body 4002 with a simple structure.

In the present embodiment, in order to easily guide the adjusting driver 4020 by the adjusting screw 4025, the sixth protruding portion 4023a and the seventh protruding portion 4023b having a longitudinal shape are provided between the fourth protruding portion 4021a and the fifth protruding portion 4021b and the adjusting screw 4025. Alternatively, one or more pairs of protruding portions corresponding to the fourth protruding portion 4021a and the fifth protruding portion 4021b may be provided instead of the sixth protruding portion 4023a and the seventh protruding portion 4023b. Specifically, a pair of protruding portions corresponding to the fourth protruding portion 4021a and the fifth protruding portion 4021b may be further provided between the fourth protruding portion 4021a and the fifth protruding portion 4021b and the adjusting screw 4025 as indicated by two-dot chain line portions indicated by reference signs 4022a and 4022b in FIG. 24. By arranging a plurality of pairs of protruding portions corresponding to the fourth protruding portion 4021a and the fifth protruding portion 4021b toward the adjusting screw 4025, the adjusting driver 4020 is easily guided to the adjusting screw 4025 as in the case of being guided by the sixth protruding portion 4023a and the seventh protruding portion 4023b.

### Vehicle Lamp

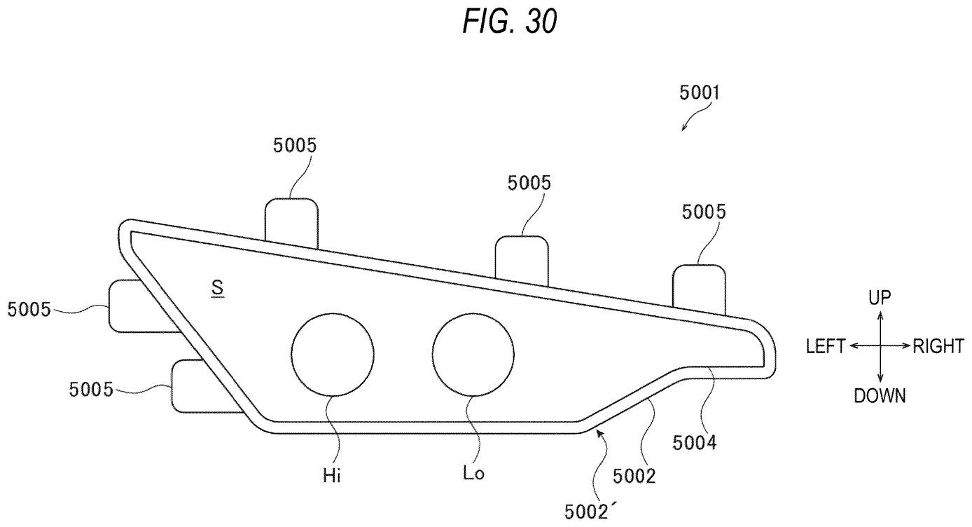

Next, an embodiment of the present disclosure will be described with reference to FIGS. 30 to 38B.

FIG. 30 is a schematic front view of a vehicle lamp 5001 according to the preferred embodiment of the present disclosure. The vehicle lamp 5001 is a headlamp that is mounted on the left and right corner portions of the front of a vehicle. As shown in FIG. 30, the vehicle lamp 5001 includes a container-shaped lamp body 5002 having a front opening 5002′, and a front cover 5004 that is attached to the front opening 5002′ of the lamp body 5002. The front cover 5004 is made of a translucent resin such as polycarbonate or glass, and the front cover 5004 is attached to the front opening 5002′ of the lamp body 5002 to define the lamp chamber S inside.

The high beam lamp unit Hi and the low beam lamp unit Lo are accommodated in the defined lamp chamber S. The high beam lamp unit Hi and the low beam lamp unit Lo are optical units that irradiate the front of the vehicle with light emitted from a light source to form a high beam light distribution or a low beam light distribution. The lamp units (Hi and Lo) may have a known configuration in the related art, such as a reflective type or a projector type lamp unit, and the type thereof does not matter.

### Overall Shape of Lamp Body

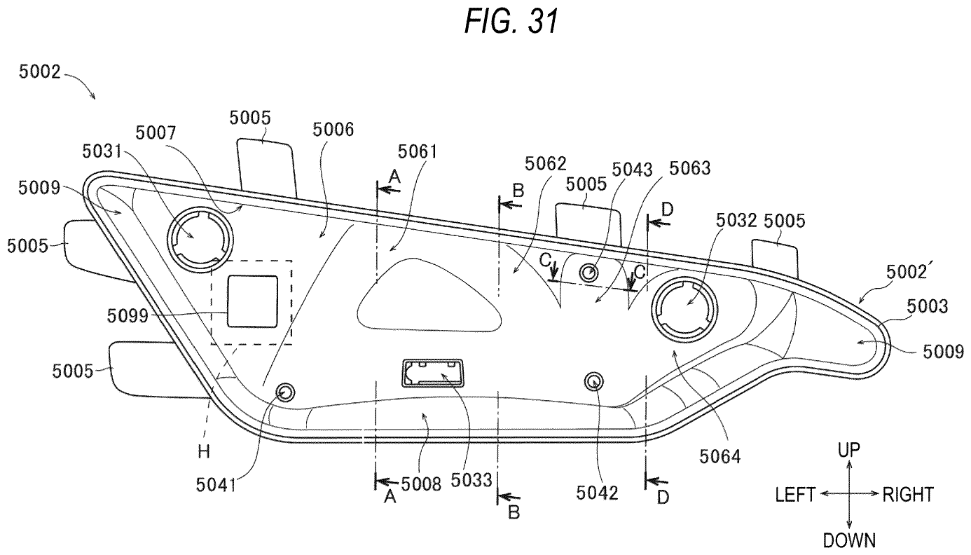

The shape of the lamp body 5002 will be described in detail. FIG. 31 is a schematic front view of the lamp body 5002.

The lamp body 5002 is molded by injection molding using a hard synthetic resin material. A seal groove 5003 for engaging with a seal leg provided on the periphery of the front cover 5004 is provided around the periphery of the front opening 5002′ of the lamp body 5002. A vehicle body attachment portion 5005 for attaching the vehicle lamp 5001 to the vehicle body is provided so as to protrude from the outer surface of the peripheral portion of the front opening 5002′ of the lamp body 5002 in a manner of corresponding to the shape of the attachment portion on the vehicle body side. The vehicle body attachment portions 5005 are provided at a total of five locations on the outer surface of the lamp body 5002, three locations on the upper side and two locations on the left side.

The lamp body 5002 includes a back wall 5006, a ceiling surface 5007, a bottom surface 5008, and left and right side surfaces 5009 as constituent surfaces. The back wall 5006 bulges rearward and is continuously connected in a curved manner to the adjacent ceiling surface 5007, bottom surface 5008, and side surfaces 5009 via the ridge lines. The ceiling surface 5007, the bottom surface 5008, and the side surfaces 5009 basically have a convex curved shape that gently bulges toward the outside of the lamp body 5002, are gently curved at the edge portions thereof, and are continuously coupled without any bent portions or steps. Therefore, the lamp body 5002 is formed in a rounded container shape as a whole.

The bottom surface 5008 extends forward from the lower edge portion of the back wall 5006, and is connected to the seal groove 5003 formed at the edge portion of the front opening 5002′ of the lamp body 5002. The side surfaces 5009 extend from the left and right edge portions of the back wall 5006 toward the lateral sides and slightly forward, and are connected to the seal groove 5003. The ceiling surface 5007 has a small extension amount, extends from the edge portion of the seal groove 5003 while gently curving rearward and downward, is connected to the back wall 5006, and is formed substantially integrally with the back wall 5006.

Therefore, the back wall 5006, the ceiling surface 5007, the bottom surface 5008, and the side surfaces 5009 and 5009 are not mainly flat but are curved surfaces having a large curvature radius, the lamp body 5002 as a whole is formed in a container shape with the back wall 5006 as a bottom portion, and each of the back wall 5006, the ceiling surface 5007, the bottom surface 5008, and the side surface 5009 forms a container surface in which curved surfaces are smoothly continuous with each other.

A first unit attachment hole 5031, a second unit attachment hole 5032, and a third unit attachment hole 5033 are formed in the lamp body 5002. The first unit attachment hole 5031 is a hole for attaching the low beam lamp unit Lo, and is formed in the upper left side of the back wall 5006. The second unit attachment hole 5032 is a hole for attaching a back cover (not shown), and is formed on the upper right side of the back wall 5006. The third unit attachment hole 5033 is a hole for attaching a light driver module (not shown) that controls lighting of the lamp units (Hi, Lo), and is formed substantially at the center of the lower portion of the back wall 5006.

In the lamp body 5002, a first aiming member attachment hole 5041, a second aiming member attachment hole 5042, and a third aiming member attachment hole 5043 are formed around the third unit attachment hole 5033. An aiming member (not shown) having a known configuration in the related art is attached to the aiming member attachment holes 5041, 5042, and 5043.

The first aiming member attachment hole 5041 is formed in the lower edge portion of the back wall 5006 so as to be formed between the first unit attachment hole 5031 and the third unit attachment hole 5033. The second aiming member attachment hole 5042 is formed in the right lower edge portion of the back wall 5006 so as to be offset from the first aiming member attachment hole 5041 in the opposite direction by approximately the same distance as the distance from the third unit attachment hole 5033 to the first aiming member attachment hole 5041. The third aiming member attachment hole 5043 is formed in the right upper end portion of the back wall 5006 so as to be formed substantially vertically above the second aiming member attachment hole 5042.

### Back Wall and Beam

A first beam 5061, a second beam 5062, a third beam 5063, and a fourth beam 5064 constituting a part of the back wall 5006 extend from the upper end portion of the back wall 5006 to the lower end portion of the back wall 5006. Here, a part of the back wall 5006 other than the part constituted by the beams 5061 to 5064 is referred to as a back wall main body 5069.

The first beam 5061 extends from the first aiming member attachment hole 5041 on the lower left side of the back wall 5006 to the upper end portion of the back wall 5006 toward the upper right. Therefore, the first beam 5061 is inclined to the right in the front view.

The second beam 5062 extends from the second aiming member attachment hole 5042 on the lower right side of the back wall 5006 to the upper end portion of the back wall 5006 toward the upper left. Therefore, the second beam 5062 is inclined to the left in the front view.

The third beam 5063 extends so as to connect the second aiming member attachment hole 5042 on the lower right side of the back wall 5006 and the third aiming member attachment hole 5043 on the upper side as end points. Therefore, the third beam 5063 extends straight to the upper end portion of the back wall 5006 generally upward in the front view.

The fourth beam 5064 extends so as to connect the second aiming member attachment hole 5042 on the lower right side of the back wall 5006 and the second unit attachment hole 5032 on the upper side as end points. Therefore, the fourth beam 5064 is inclined to the right in the front view.

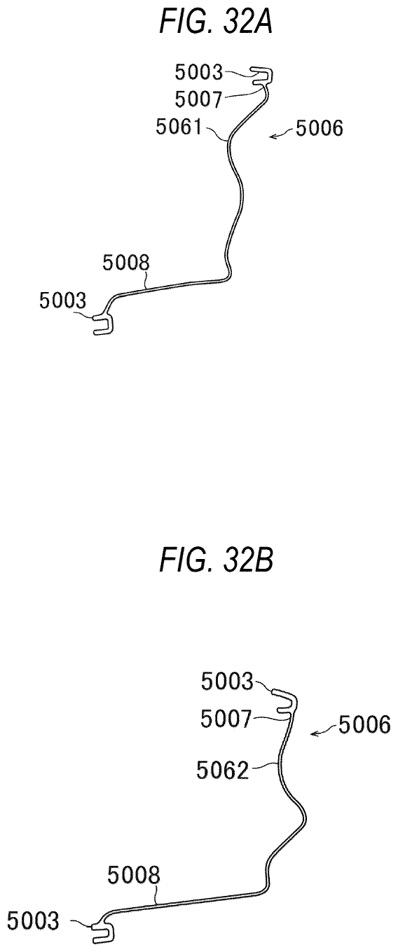

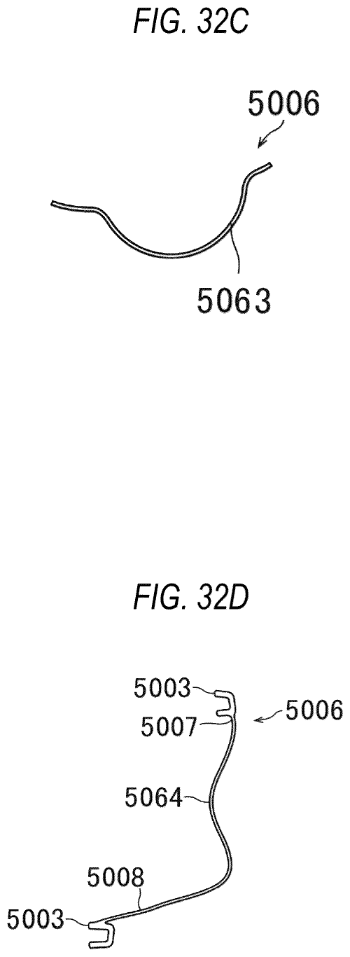

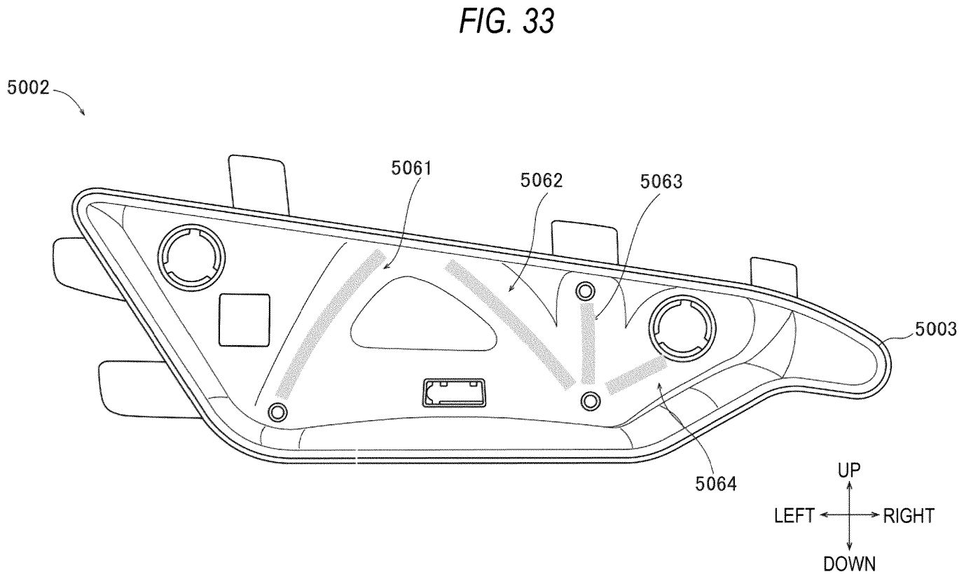

FIGS. 32A to 32D are end views of the beams 5061 to 5064 along the cutting line shown in FIG. 31. FIG. 32A is an end view taken along a line A-A in FIG. 31, and mainly shows the cross-sectional shape of the first beam 5061. FIG. 32B is an end view taken along a line B-B in FIG. 31, and mainly shows the cross-sectional shape of the second beam 5062.

FIG. 32C is an end view taken along a line C-C in FIG. 31, and mainly shows the cross-sectional shape of the third beam 5063. FIG. 32D is an end view taken along a line D-D in FIG. 31, and mainly shows the cross-sectional shape of the fourth beam 5064.

As shown in FIGS. 32A to 32D, the cross-sectional shapes of the beams 5061 to 5064 perpendicular to the extending direction thereof are all a substantially arc shape, although differ in radius of curvature, width, and amount of protrusion. The protruding direction of the curved surface of each of the beams 5061 to 5064 may be formed in either the direction (forward) toward the lamp chamber S or the outward direction (rearward) of the lamp chamber S, and in the present embodiment, the beams 5061 to 5064 are formed as beams curved toward the direction (forward) toward the lamp chamber S. The beams 5061 to 5064 are smoothly connected to the back wall main body 5069 via the ridge lines. The cross-sectional shape of the lamp body 5002 is constructed continuously without any bent portions while maintaining a constant wall thickness.

FIG. 33 is a front view of the lamp body 5002, and shows the beams 5061 to 5064 in light black. As shown in FIG. 33, the beams 5061 to 5064 have a truss structure in triangular units. In the truss structure, the beams 5061 to 5064 extend from the upper end portion to the lower end portion of the back wall 5006, and one beam extends obliquely from the end portion of another beam. Here, the thick seal groove 5003 is incorporated in the truss structure. Therefore, the lamp body 5002 including the back wall 5006 has a structure that is less likely to deform under a load. Since the beams 5061 to 5064 themselves have curved surfaces having a substantially arc-shaped cross section to disperse stress, the beams 5061 to 5064 have a highly rigid structure that is more resistant to deformation.

Therefore, the lamp body 5002 according to the present embodiment has a structure having higher rigidity than a lamp body that does not have such a truss structure. By improving the rigidity of the lamp body 5002, the lamp body 5002 is thinner than the lamp body in the related art and has the same rigidity as the lamp body in the related art.

### Engaging Structure

An engaged member 5099 provided in the lamp chamber S is directly engaged with the lamp body 5002 by an engaging structure provided in the lamp body 5002. The engaging structure provided in the lamp body 5002 will be described in detail.

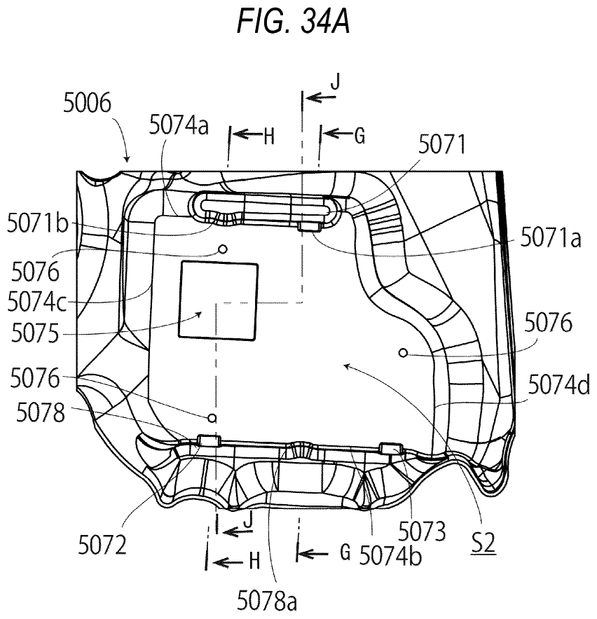

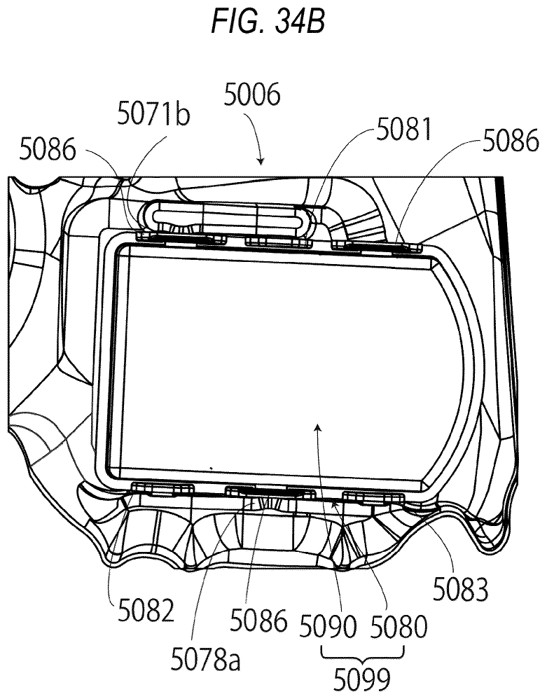

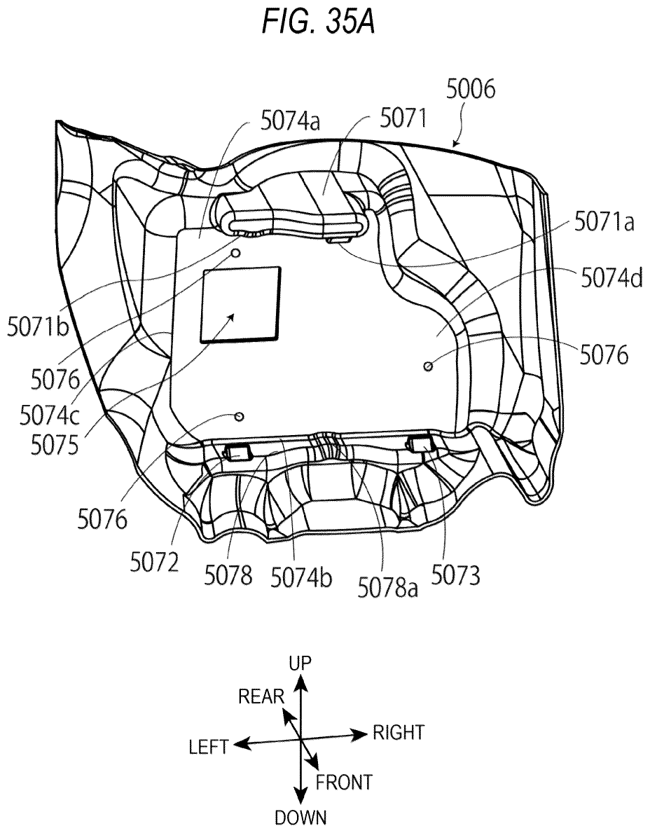

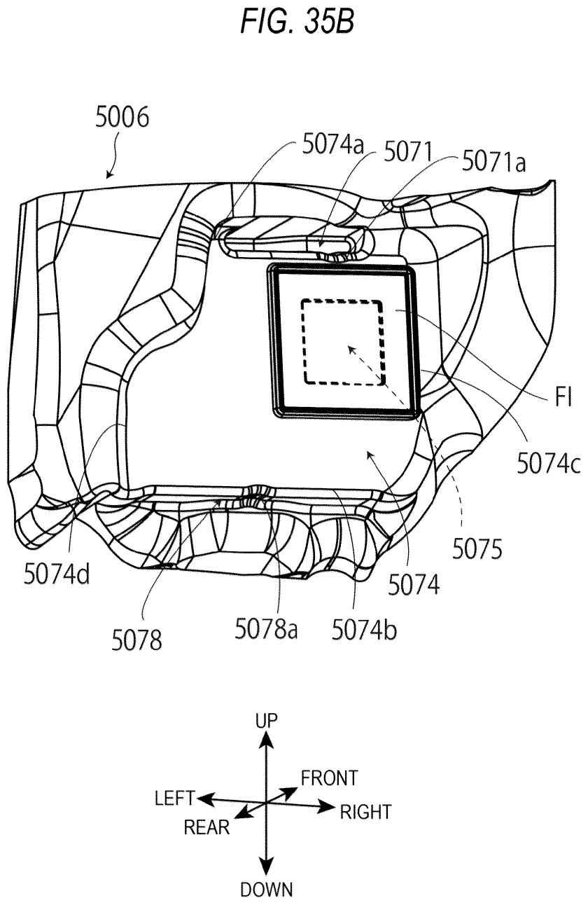

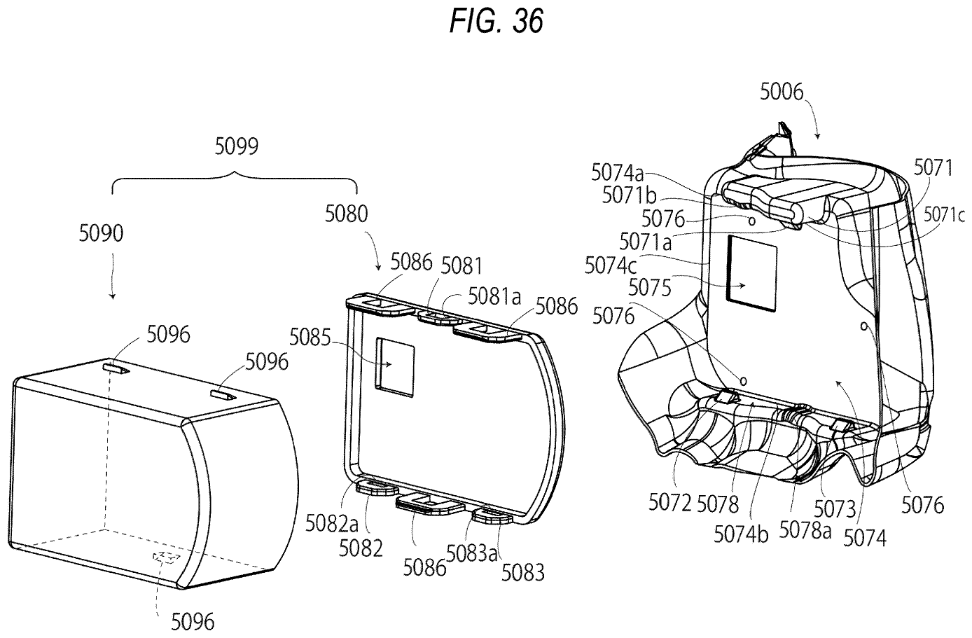

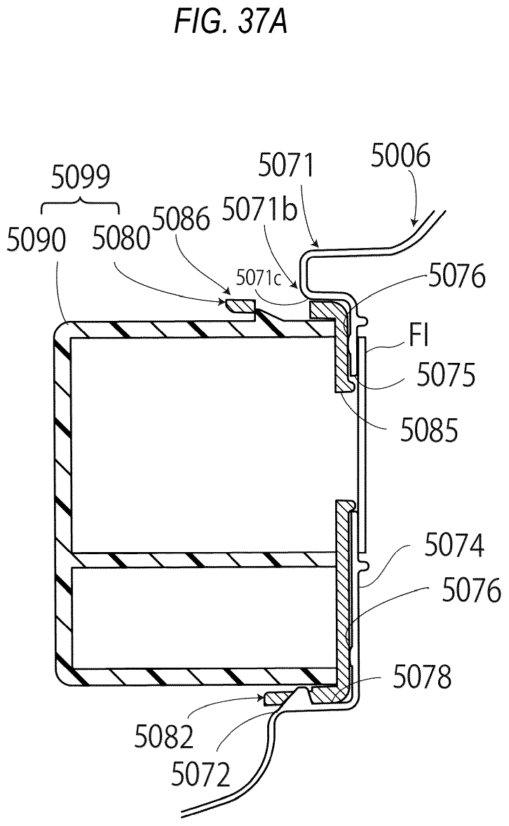

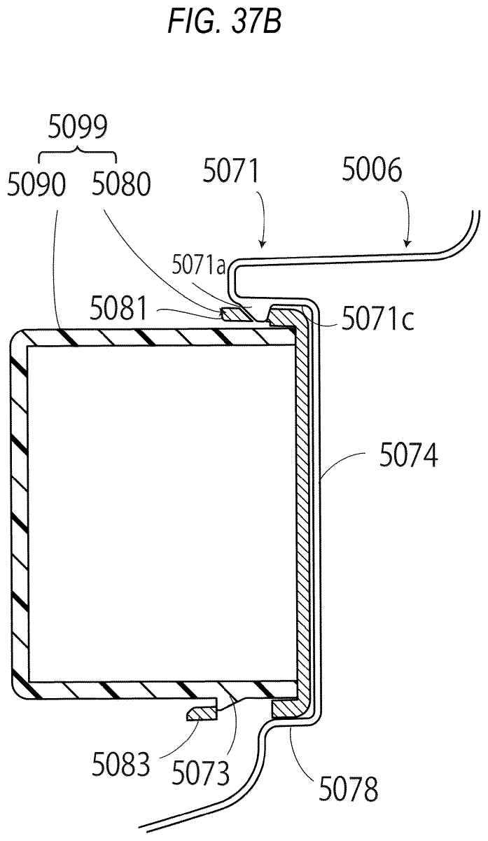

FIGS. 34A to 37B show the portion H shown in FIG. 31. The engaged member 5099 is engaged with the portion H of the lamp body 5002. FIGS. 34A and 34B are front views of the portion H shown in FIG. 31. FIG. 34A shows a state (before engagement) in which only the lamp body 5002 is provided and in which the engaged member 5099 is not engaged. FIG. 35A is a front perspective view of the lamp body 5002 of the portion H. FIG. 35B is a rear perspective view of the lamp body 5002 of the portion H. FIG. 36 is an exploded perspective view of the portion H. FIG. 37A is an end view taken along a line H-H shown in FIG. 34A. FIG. 37B is an end view taken along a line J-J shown in FIG. 34A.

The engaged member 5099 engaged with the lamp body 5002 is a dehumidifying unit and has a function of discharging the moisture in the lamp chamber S to the outside of the lamp chamber S. The engaged member 5099 is not limited thereto, and may be a component provided in the lamp chamber S, such as a leveling actuator or a driver circuit, and the shape and the size thereof are not limited.

As shown in FIG. 36, the engaged member 5099 includes an engaged member main body 5090 and a cover 5080. The engaged member main body 5090 has a substantially rectangular parallelepiped outer shape, and a total of three protrusions are formed as a cover engaged portion 5096, two on the upper surface and one on the bottom surface.

The cover 5080 is formed in a flat plate shape, covers the back surface of the engaged member main body 5090 like a lid, and is fixed to the engaged member main body 5090. A cover engaging portion 5086 corresponding to cover engaged portion 5096 is provided at the upper edge portion and the lower end portion of cover 5080, and the engaged member main body 5090 and the cover 5080 are integrated to form the engaged member 5099 by engaging the cover engaging portion 5086 with the cover engaged portion 5096. The engagement between the cover 5080 and the engaged member main body 5090 may be performed using an engaging structure in the related art such as unevenness engagement or lance engagement, and is not particularly limited. The cover 5080 may be fastened to the engaged member main body 5090 using a fixing member such as a screw.

The upper edge portion and the lower end portion of the cover 5080 are further formed with flat plate-shaped female engaging portions 5081 to 5083 that horizontally protrude forward. Engaging holes 5081a to 5083a are formed in the central portion of the female engaging portions 5081 to 5083.

The first female engaging portion 5081 is provided between the two cover engaging portions 5086 at the center of the upper edge portion of the cover 5080. The second female engaging portion 5082 and the third female engaging portion 5083 are provided on the lower edge portion of the cover 5080 with the cover engaging portion 5086 interposed therebetween, and the female engaging portions 5081 to 5083 are arranged alternately with the three cover engaging portions 5086.

When the cover 5080 is engaged with and integrated with the engaged member main body 5090, the female engaging portions 5081 to 5083 provided on the cover 5080 are provided on the upper surface and the lower surface of the engaged member 5099. The female engaging portions 5081 to 5083 may be directly provided on the upper surface and the lower surface of the engaged member main body 5090 without using the cover 5080.

The engaging structure provided in the lamp body 5002 will be described. A vertical plane portion 5074 that abuts against the engaged member 5099 when the engaged member 5099 is engaged is formed in a partial region of the back wall 5006 mainly implemented by a curved surface.

The vertical plane portion 5074 is formed in a substantially rectangular shape corresponding to the abutting surface (the back surface) of the substantially rectangular parallelepiped engaged member 5099. The vertical plane portion 5074 has sides including an upper side 5074a, a lower side 5074b, a left side 5074c, and a right side 5074d.

The back wall 5006 is bent from the left side 5074c and the right side 5074d of the vertical plane portion 5074 toward the back surface side (rearward), and is bent forward at a substantially right angle from the lower side 5074b of the vertical plane portion 5074.

Therefore, a horizontal portion 5078 is formed continuously from the lower end of the vertical plane portion 5074. The back wall 5006 is further bent downward at the front end of the horizontal portion 5078, and the horizontal portion 5078 is implemented as a horizontal surface of the back wall 5006 formed in a stepped shape.

When the engaged member 5099 is engaged, a part of the engaged member 5099 is placed on the horizontal portion 5078.

A surface of the horizontal portion 5078 is formed with a second male engaging portion 5072 and a third male engaging portion 5073 that are protrusions (lances) and that protrude upward.

Further, a first male engaging portion 5071 protrudes forward from the upper side 5074a. A lance 5071a protruding downward is formed on the surface of a bottom surface portion 5071c of the first male engaging portion 5071 that comes into contact with the engaged member 5099.

The first male engaging portion 5071, the second male engaging portion 5072, and the third male engaging portion 5073 are formed corresponding to the first female engaging portion 5081, the second female engaging portion 5082, and the third female engaging portion 5083, respectively. The back surface of the engaged member 5099 abuts against the vertical plane portion 5074, and the female engaging portions 5081 to 5083 are engaged with the male engaging portions 5071 to 5073, respectively, so that the engaged member 5099 is directly fixed to the back wall 5006 of the lamp body 5002 without a fixing member such as a bolt or a screw.

The engagement between the female engaging portions 5081 to 5083 and the male engaging portions 5071 to 5073 is so-called lance engagement.

The lance engagement is implemented such that an engaging resistance is temporarily generated in the female engaging portion or the male engaging portion in an engagement process of the engaging portions, and when the engaging resistance is overcome and the engaging portion passes through, a moderation feeling (a click feeling) is given to an operator by alleviation of the engaging resistance, and both the engaging portions are brought into an engaging state by the momentum at the time of passing. A part of the passing portion of the male engaging portion has a folded shape (a lance), and once the male engaging portion is engaged with the female engaging portion, the lance is caught by the female engaging portion to prevent disengagement and maintain the engaging state.

The first male engaging portion 5071 is hollow and is formed by a part of the back wall 5006. That is, as shown in FIG. 37A, the first male engaging portion 5071 is formed on the back wall 5006 so as to protrude forward, and the first male engaging portion 5071 is formed by the back wall 5006 continuous from the upper side 5074a of the vertical plane portion 5074 once bending forward, then bending upward, and further folding back and bending rearward. Therefore, the first male engaging portion 5071 constitutes a part of the back wall 5006 and is hollow.

Similarly, the horizontal portion 5078 formed by bending the lower side 5074b of the vertical plane portion 5074 also constitutes a part of the back wall 5006. That is, the vertical plane portion 5074, the horizontal portion 5078, and the first male engaging portion 5071 are all continuous and constitute a part of the back wall 5006. The engaged member 5099 is fitted and accommodated in a space S2 formed by the vertical plane portion 5074, the horizontal portion 5078, and the first male engaging portion 5071.

### Advantageous Effects

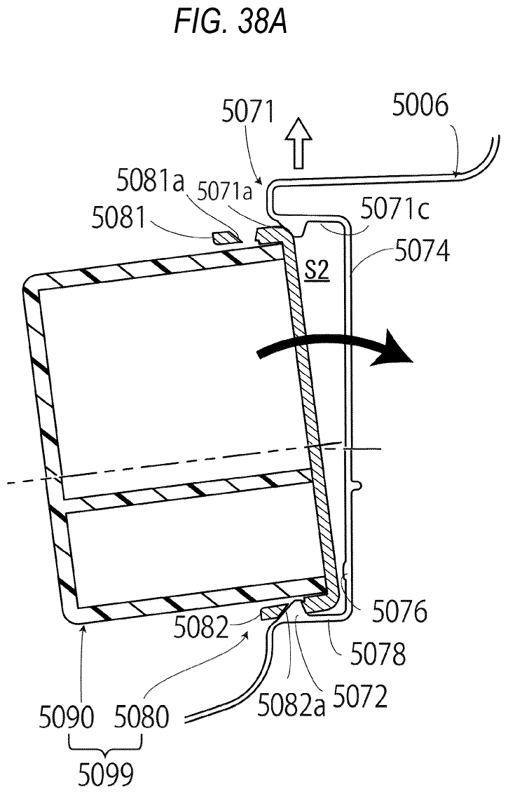

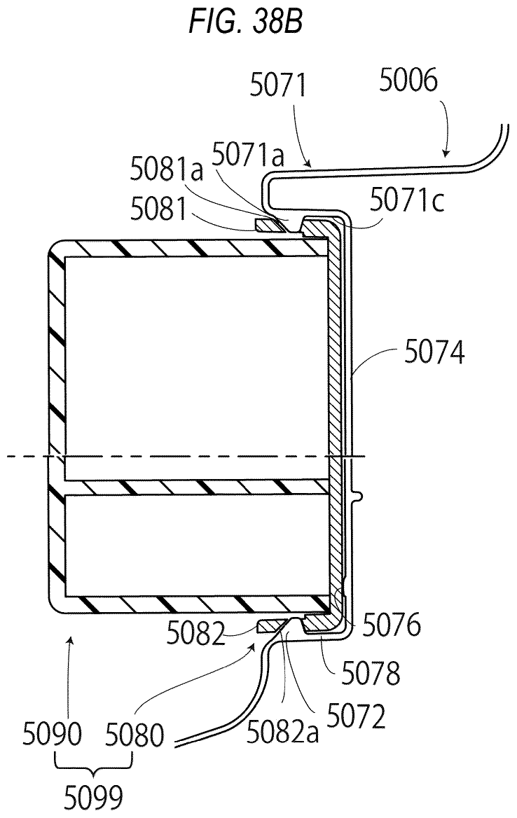

The advantageous effects of the present configuration will be described with reference to FIGS. 38A and 38B. FIGS. 38A and 38B are end views taken along a line J-J shown in FIG. 34A, and show a process in which the engaged member 5099 engages with the lamp body 5002.

As described above, the engagement between the female engaging portions 5081 to 5083 and the male engaging portions 5071 to 5073 is lance engagement, and either or both of the female engaging portions 5081 to 5083 and the male engaging portions 5071 to 5073 are elastically deformed against the engaging resistance, so that the lance overcomes the engaging resistance and passes through to reach the engaging state.

When the engaged member 5099 is engaged with the back wall 5006, first, the second female engaging portion 5082 and the third female engaging portion 5083 that are provided on the bottom surface of the engaged member 5099 are hooked and engaged with the second engaging hole 5072a and the third engaging hole 5073a by being fitted to the second male engaging portion 5072 and the third male engaging portion 5073 of the horizontal portion 5078 from obliquely above (see FIG. 38A). Next, the engaged member 5099 is pressed toward the vertical plane portion 5074 on the back surface by rotating the engaged member 5099 with the engaged two points as fulcrums. The first male engaging portion 5071 is pushed up by the engaged member 5099 attempting to move rearward, and is elastically deformed so as to open upward (see the white arrow in FIG. 38A). Accordingly, the space S2 is widened, and the lance 5071a protruding toward the space S2 climbs over the first female engaging portion 5081 and is fitted into the first engaging hole 5081a, resulting in the engaging state (see FIG. 38B). The elastic deformation of the first male engaging portion 5071 returns to the original state with no load, and the engaged member 5099 is retained and fixed to the back wall 5006.

In this way, the engaged member 5099 is engaged with the lamp body 5002 by elastically deforming at least a part of the lamp body 5002 constituting the engaging portion and the lamp body 5002 in the vicinity of the engaging portion. A fixing member such as a bolt or a screw is unnecessary, and the engaged member 5099 can be directly and easily engaged with the engaging portion provided in the lamp body 5002.

The elastic deformation of the lamp body 5002 for engagement may be achieved by the shape of the lamp body 5002, or may be achieved by thinning the lamp body 5002. By thinning the portion to be engaged, the lamp body 5002 is easily elastically deformed, and the engaged member 5099 can be directly engaged with the lamp body 5002 by the engaging portion provided in the lamp body 5002.

As in the first male engaging portion 5071, when the engaging portion is a hollow protrusion formed by the lamp body 5002, it is preferable that the engaging portion itself is easily elastically deformed while forming the lamp body 5002. The protruding hollow first male engaging portion 5071 is not essential, and for example, the first male engaging portion 5071 may also be formed in a stepped shape similarly to the horizontal portion 5078. In this case, the space S2 is implemented as a recess recessed from the back wall 5006 to the back surface, and a lance is formed on a constituent surface constituting the recess.

Since the lamp body 5002 according to the present embodiment is mainly formed of a curved surface, the rigidity is increased, the thickness is reduced as compared with the related art while ensuring the same degree of rigidity as the related art, and the lamp body 5002 is easily elastically deformed and has resistance to the deformation load. At the time of engagement, since the entire lamp body 5002 is elastically deformed around the engaging portion, the load is distributed to the entire lamp body 5002, and the lamp body 5002 is less likely to be broken even if the lamp body 5002 is deformed. This is suitable for the present engaging structure in which at least a part of the lamp body 5002 is elastically deformed to enter the engaging state at the time of engagement.

The entire lamp body 5002 does not need to be elastically deformed, and a partial region necessary for engagement may be elastically deformed alone. When the region where the lamp body 5002 is elastically deformed at the time of engagement is wide, the load due to the elastic deformation is distributed accordingly, and the breakage of the engaging portion due to the engagement load is prevented, which is preferable.

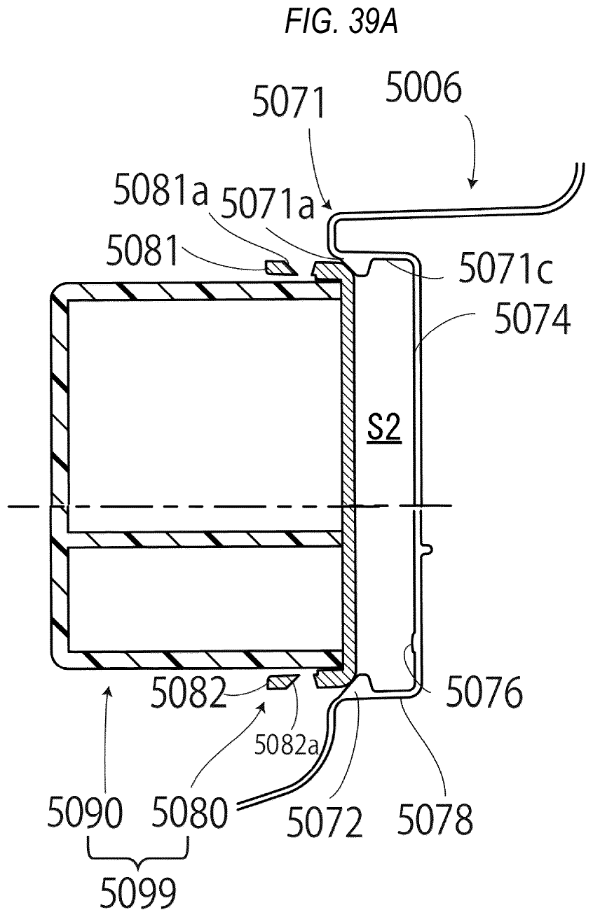

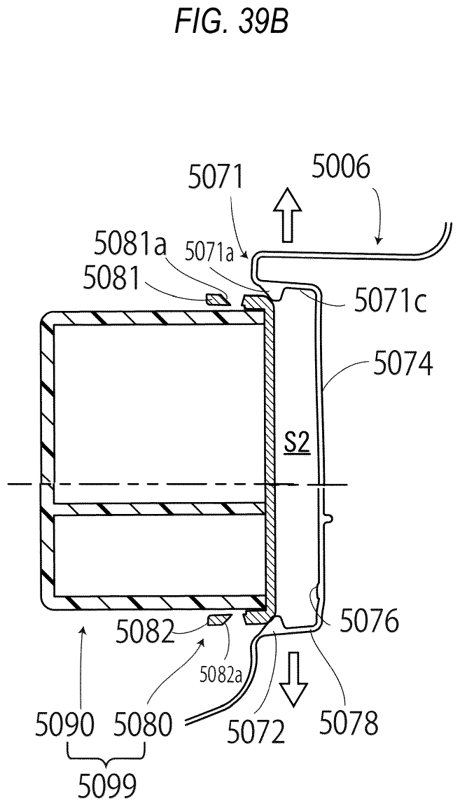

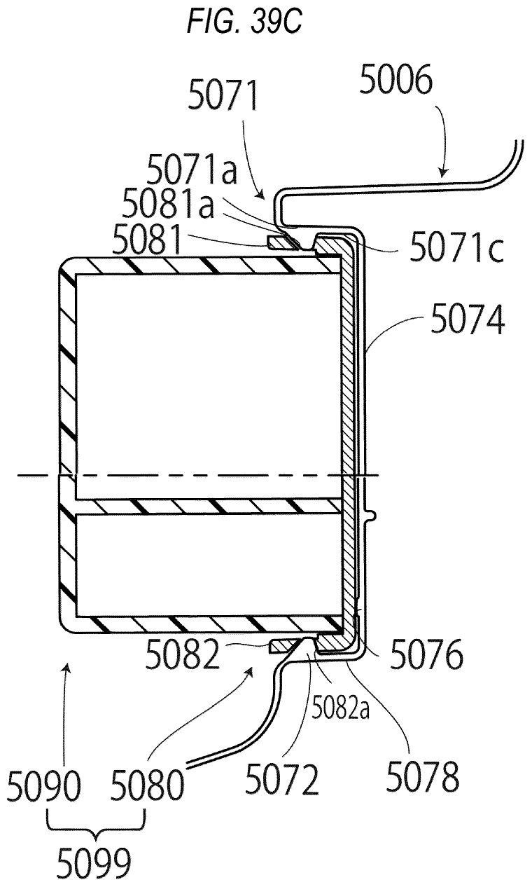

The engaged member 5099 may be engaged by deforming the entire engaging portion in a wide range around the engaging portion including the first male engaging portion 5071. The engagement process in this case will be described with reference to FIGS. 39A to 39C.

FIGS. 39A to 39C are end views taken along the line J-J shown in FIG. 34A, and show another process in which the engaged member 5099 engages with the lamp body 5002.

First, the engaged member 5099 is provided in the space S2 sandwiched between the horizontal portion 5078 and the first male engaging portion 5071 (see FIG. 39A). Next, the engaged member 5099 is pushed into the space S2 and moved in the back surface direction (see FIG. 39B). The first male engaging portion 5071 provided with the lance 5071a and the horizontal portion 5078 provided with the second male engaging portion 5072 and the third male engaging portion 5073 are opened in the upper-lower direction so as to widen the space S2 by the engaged member 5099 that attempts to enter the space S2 (see the white arrow in FIG. 39B). The space S2 is widened by the deformation of the back wall 5006, and the lance 5071a, the second male engaging portion 5072, and the third male engaging portion 5073 that protrude toward the space S2 are fitted into the engaging holes 5081a to 5083a by the female engaging portions 5081 to 5083 riding over the lance 5071a, the second male engaging portion 5072, and the third male engaging portion 5073, resulting in the engaging state (see FIG. 39C). The elastically deformed first male engaging portion 5071 and the horizontal portion 5078 return to the original state without load or deformation, and the lance 5071a, the second male engaging portion 5072, and the third male engaging portion 5073 that are provided in the first male engaging portion 5071 and the horizontal portion 5078 retain and fix the engaged member 5099.

In this engaging process, the horizontal portion 5078 provided with the second male engaging portion 5072 and the third male engaging portion 5073 is elastically deformed and engaged with the second female engaging portion 5082 and the third female engaging portion 5083. Therefore, the horizontal portion 5078 is also provided in a part of the engaging portion. The vertical plane portion 5074 is also warped and elastically deformed to achieve engagement, and the lamp body 5002 around the region where the space S2 is formed is entirely deformed to achieve engagement.

As shown in FIG. 36, since the engaged member 5099 is a dehumidifying unit, the cover 5080 is formed with a cover opening 5085 serving as a moisture outlet. The vertical plane portion 5074 of the lamp body 5002 is also formed with a lamp body opening 5075 corresponding to the cover opening 5085 and a filter FI covering the lamp body opening 5075 (see FIGS. 35B and 37A). As shown in FIG. 37A, when the engaged member 5099 is engaged, both openings communicate with each other.

Since the engaged member 5099 is not limited to the dehumidifying unit, both openings are not essential. However, by directly fixing the dehumidifying unit to the lamp body 5002 in this way, it is not necessary to provide an air duct from the moisture discharge port of the dehumidifying unit to the moisture discharge port of the lamp body, and it is possible to reduce the size and the weight of the vehicle lamp 5001. Similarly, when the engaged member 5099 is provided such that a component taken out of the lamp chamber S from the engaged member 5099 through the opening of the lamp body 5002, for example, a connector port or a cable is exposed from the opening of the lamp body 5002 in the engaging state, the space of the lamp chamber S is saved, and the size and the weight of the vehicle lamp 5001 can be reduced, which is preferable.

As shown in FIGS. 38A and 38B, a protrusion 5076 is provided on the surface of the vertical plane portion 5074. The protrusion 5076 protrudes toward the space S2 and serves as a contact portion of the engaged member 5099 to be provided. That is, the protruding protrusion 5076 presses the back surface of the engaged member 5099 to be engaged, and the engagement is strengthened by the counter force against the pressing. The protrusions 5076 are provided at three positions on the vertical plane portion 5074, and the number and the positions of the protrusions 5076 are not limited thereto. In order to attain the same effect, a protrusion may be provided on the abutting surface (the back surface) of the engaged member 5099.

Similarly, as shown in FIGS. 34A and 34B, the bottom surface portion 5071c of the first male engaging portion 5071 is provided with a first expansion portion 5071b that expands toward the space S2. A second expansion portion 5078a that expands toward the space S2 is also provided at the center of the horizontal portion 5078. The first expansion portion 5071b and the second expansion portion 5078a guide the arrangement of the engaged member 5099 and press the engaged member 5099 to strengthen the engagement of the engaging portions.

Although the preferred embodiment of the present disclosure has been described above, the above embodiment is an example of the present disclosure. It is possible to combine these embodiments based on the knowledge of those skilled in the art, and such forms are also included within the scope of the present disclosure.

The present application is based on Japanese Patent Application No. 2022-212374 filed on Dec. 28, 2022, Japanese Patent Application No. 2023-006317 filed on Jan. 19, 2023, Japanese Patent Application No. 2023-018119 filed on Feb. 9, 2023, Japanese Patent Application No. 2023-019511 filed on Feb. 10, 2023, and Japanese Patent Application No. 2023-019516 filed on Feb. 10, 2023, the contents of which are incorporated herein by reference.

1. A vehicle lamp comprising:
a lamp body having an opening in a front surface of the lamp body; and
a front lens that is attached to the opening in the front surface of the lamp body and that forms a lamp chamber inside the lamp body,
wherein the lamp body includes, inside the lamp chamber:
a component support portion; and
a semi-cylindrical portion having a semi-cylindrical shape in cross section and surrounding both sides of the component support portion.

2. The vehicle lamp according to claim 1,
wherein the semi-cylindrical portion is formed from one end of the opening in the front surface of the lamp body to an other end of the opening in the front surface of the lamp body, the one end facing the other end.

3. The vehicle lamp according to claim 2,
wherein the semi-cylindrical portion includes:
a first semi-cylindrical portion having one end continuously formed in the opening in the front surface of the lamp body; and
a plurality of second semi-cylindrical portions that are formed to offset from the other end of the first semi-cylindrical portion in a width direction, that surround both sides of the component support portion, and that have an other end continuously formed at a position facing the one end of the first semi-cylindrical portion in the opening in the front surface of the lamp body.

4. The vehicle lamp according to claim 1,
wherein the opening of the lamp body is formed with a seal portion along the opening.

5. The vehicle lamp according to claim 1,
wherein the component support portion is an attachment hole for a component provided in the lamp body.

6. A vehicle lamp comprising:
a container-shaped lamp body whose front surface is opened;
a front cover that is assembled to a front opening of the lamp body and that defines a lamp chamber inside; and
an in-lamp structure provided in the lamp chamber,
wherein a plurality of beams having a substantially arc shape in cross section and formed by a part of a container surface of the lamp body extend in a truss shape on the container surface, and
wherein the in-lamp structure is supported by at least one of the beams.

7. The vehicle lamp according to claim 6,
wherein the in-lamp structure is provided on a beam on which an axial force in a compression direction acts among the beams.

8. The vehicle lamp according to claim 68,
wherein the in-lamp structure is long, and a longitudinal direction of the in-lamp structure is aligned with an axial direction of the beam.

9. The vehicle lamp according to claim 8,
wherein at least one undulation is formed in the longitudinal direction of the in-lamp structure on the container surface in a vicinity of the beam that supports the in-lamp structure.

10. The vehicle lamp according to claim 6,
wherein the in-lamp structure is fixed so as to be coupled to the container surface different from the container surface including the beam that supports the in-lamp structure.

11. A vehicle lamp comprising:
a container-shaped lamp body whose front surface is opened; and
a front cover that is assembled to a front opening of the lamp body and that defines a lamp chamber inside,
wherein, when the lamp body is viewed in a cross section along a certain direction, the cross section is formed such that unevenness is continuous.

12. The vehicle lamp according to claim 11,
wherein, in a partial region of the lamp body, the unevenness forms a substantially petaloid shape.

13. The vehicle lamp according to claim 12,
wherein an opening is formed at a center of the substantially petaloid shape.

14. The vehicle lamp according to claim 12,
wherein the substantially petaloid shape includes a first petal that is the first unevenness when viewed from a center of the substantially petaloid shape in a radial direction, and a second petal that is the second unevenness when viewed from the center of the substantially petaloid shape in the radial direction.

15. (Canceled)

16. (Canceled)

17. (Canceled)

18. (Canceled)

19. (Canceled)

20. (Canceled)

21. (Canceled)

22. (Canceled)

23. (Canceled)

24. (Canceled)

25. (Canceled)
